(19) United States
(12) Patent Application Publication
(10) Pub. No.: US 2026/0169413 A1
(43) Pub. Date: Jun. 18, 2026

(54) IMAGE FORMING APPARATUS

(71) Applicants: Koichi YAMAWAKI, Tokyo (JP); Tatsumi YAMADA, Kanagawa (JP); Shotaro HOSHI, Kanagawa (JP); Kazuya SAITO, Kanagawa (JP); Kenji YABE, Kanagawa (JP); Naoyuki OZAKI, Kanagawa (JP)

(72) Inventors: Koichi YAMAWAKI, Tokyo (JP); Tatsumi YAMADA, Kanagawa (JP); Shotaro HOSHI, Kanagawa (JP); Kazuya SAITO, Kanagawa (JP); Kenji YABE, Kanagawa (JP); Naoyuki OZAKI, Kanagawa (JP)

(21) Appl. No.: 19/404,035

(22) Filed: Dec. 1, 2025

(30) Foreign Application Priority Data
Dec. 16, 2024 (JP) 2024-220182
Feb. 6, 2025 (JP) 2025-018263

(51) Int. Cl. G03G 15/00; G03G 15/08; G03G 21/16

(52) U.S. Cl. CPC G03G 15/553; G03G 15/0863; G03G 15/0894; G03G 15/5058; G03G 15/5062; G03G 21/1676; G03G 2215/00059; G03G 2215/00067; G03G 2215/0697; G03G 2221/163

(57) ABSTRACT

An image forming apparatus includes an apparatus body, a latent image bearer, a development unit, and processing circuitry. The development unit develops a latent image on the latent image bearer. The development unit is detachable from the apparatus body. The processing circuitry determines a lifetime of the development unit. The processing circuitry detects whether a replacement development unit attached to the apparatus body by replacement is a reuse item, and forms a degradation state detection image to ascertain a degradation state of the replacement development unit of the reuse item when the processing circuitry detects that the replacement development unit is the reuse item, and sets a remaining lifetime of the replacement development unit of the reuse item based on the degradation state detection image.

### CROSS-REFERENCE TO RELATED APPLICATIONS

This patent application is based on and claims priority pursuant to 35 U.S.C. § 119(a) to Japanese Patent Application Nos. 2024-220182, filed on Dec. 16, 2024, and 2025-018263, filed on Feb. 6, 2025, in the Japan Patent Office, the entire disclosure of each of which is hereby incorporated by reference herein.

### BACKGROUND

### Technical Field

The present disclosure relates to an image forming apparatus.

### Related Art

Image forming apparatuses including a development unit that is detachable from an apparatus body and develops a laten image on a latent image bearer, and a controller that determines a lifetime of the development unit are known.

For example, an image forming apparatus includes an image unit including a photoconductor and a development unit detachably disposed to an apparatus body, and determines a lifetime of the image unit as follows. That is, a drive time of a developing roller (also referred to as a developing roller drive time) is stored in a memory of the apparatus body, and the image forming apparatus determines that the image unit is at the end of its lifetime if the developing roller drive time stored in the memory of the apparatus body exceeds a threshold value. When the image forming apparatus detects that the image unit has been replaced, the image forming apparatus checks whether new item information is present in a memory disposed in a replacement image unit that has been attached. In a case where the image forming apparatus determines that the replacement image unit is a reuse item such as an old item because new item information is not present, the image forming apparatus checks whether a developing roller drive time stored in the memory of the replacement image unit is greater than the developing roller drive time stored in the memory of the apparatus body. If the developing roller drive time stored in the memory of the replacement image unit is greater than the developing roller drive time stored in the memory of the apparatus body, the image forming apparatus updates the developing roller drive time stored in the memory of the apparatus body to the developing roller drive time stored in the memory of the replacement image unit.

### SUMMARY

The present disclosure described herein provides an image forming apparatus that includes an apparatus body, a latent image bearer, a development unit, and processing circuitry. The development unit develops a latent image on the latent image bearer. The development unit is detachable from the apparatus body. The processing circuitry determines a lifetime of the development unit. The processing circuitry detects whether a replacement development unit attached to the apparatus body by replacement is a reuse item, and forms a degradation state detection image to ascertain a degradation state of the replacement development unit of the reuse item when the processing circuitry detects that the replacement development unit is the reuse item, and sets a remaining lifetime of the replacement development unit of the reuse item based on the degradation state detection image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic front view of a color copier, illustrating an overall configuration of the color copier;

FIG. 2 is a schematic diagram illustrating a general configuration of one of four image forming units;

FIG. 3 is a diagram illustrating a development unit and a photoconductor drum in a longitudinal direction;

FIG. 4 is a functional block diagram illustrating a color copier;

FIG. 5 is a functional block diagram illustrating a toner concentration sensor;

FIGS. 6A and 6B are diagrams illustrating a detection substrate that detects a “new item”, “reuse item”, or “attached item”;

FIG. 7 is a flowchart of a replacement initial operation;

FIG. 8 is a diagram illustrating a relation between a development potential and a toner adhesion amount:

FIG. 9A is a graph illustrating a relation between background stains and a printed sheet quantity;

FIG. 9B is a graph illustrating a relation between a toner scattering accumulation amount and a printed sheet quantity;

FIG. 10 is a graph illustrating a relation between a quantity of white spots to be generated on an image with adhesion of carrier and a printed sheet quantity;

FIG. 11 is a flowchart illustrating a degradation state estimation mode,

FIG. 12 is a graph illustrating a relation between a background stains image density and a background potential;

FIG. 13 is a graph illustrating a relation between a quantity of generated white spots, a development potential, and a primary transfer current.

FIG. 14 is a graph illustrating a relation between a calculated image density of a background stain detection image and a remaining lifetime;

FIG. 15A is a diagram illustrating a white spot detection image on a prescribed sheet prior to a predetermined image process;

FIG. 15B is a diagram illustrating a white spot detection image subsequent to the predetermined image process;

FIG. 16 is a graph illustrating a relation between a quantity of detected white spots and a remaining lifetime (%);

FIG. 17 is a flowchart illustrating a modification of the degradation state estimation mode;

FIG. 18 is a diagram illustrating one example of a home screen;

FIG. 19 is a diagram illustrating one example a developing unit replacement time setting screen;

FIG. 20 is a diagram illustrating one example of an image density rank input screen;

FIG. 21 is a diagram illustrating one example of a white spot rank input screen;

FIGS. 22A and 22B are diagrams illustrating a case in which a remaining lifetime is specified based on an image density rank;

FIGS. 23A and 23B are diagrams illustrating a case in which a remaining lifetime is specified based on a white spot rank; and

FIG. 24 is a diagram illustrating one example of a warning display asking whether to correct a selected rank.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure are described with reference to the drawings. Note that a person skilled in the art could easily conceive of another embodiment by changing or modifying the following embodiments within the scope of the claims of the present disclosure. Thus, the scope of the claims of the present disclosure encompasses such changes and modifications. The following embodiments are merely examples, and are not intended to limit the scope of the claims of the present disclosure.

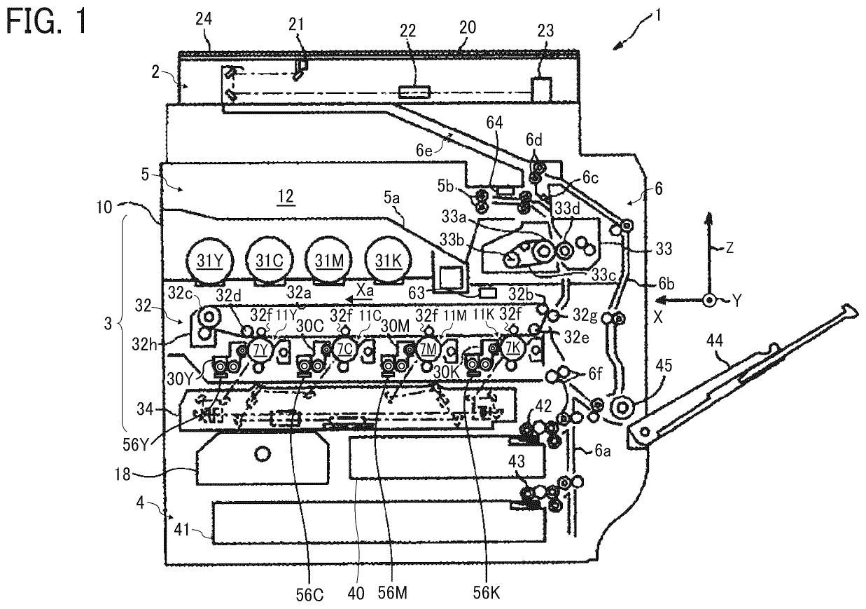

FIG. 1 is a schematic front view perspectively illustrating an overall configuration of a color copier 1 as one example of an image forming apparatus according to an embodiment of the present disclosure. In FIG. 1, the color copier 1 as the image forming apparatus according to the embodiment is an internal sheet output type color copier employing an electrophotographic method. In FIG. 1, a Z direction indicates a vertical direction, a Y direction indicates a front-back direction (an axial direction) of the apparatus, and an X direction indicates a horizontal direction of the apparatus.

The color copier 1 includes an apparatus body 10 that is a housing of the entire image forming apparatus, and a scanner 2 that reads an image of a document. The apparatus body 10 has a roughly box shape, and the scanner 2 is disposed above the apparatus body 10. The color copier 1 also includes an image forming device 3 that is disposed inside the apparatus body 10. The image forming device 3 records and forms an image on paper as one example of a sheet based on image information read by the scanner 2 or image information transmitted from a device such as a personal computer of an external device.

The color copier 1 also has a sheet output space 12 as an ejection space to which a sheet on which an image has been recorded is ejected. The sheet output space 12 is arranged between the scanner 2 and the image forming device 3. In a lowermost area of the apparatus body 10, a sheet feeder 4 is disposed. The sheet feeder 4 feeds a sheet (representing a sheet-type recording medium including copy paper, a resin sheet for overhead projector (OHP), thick paper, and a postcard) to a paper conveyance path as a sheet conveyance path. Moreover, an internal output unit 5 that outputs the sheet on which the image has been recorded is arranged in the sheet output space 12 above the image forming device 3, and a sheet conveyance path 6 is arranged between the sheet feeder 4 and the internal output unit 5.

The scanner 2 includes an exposure glass 20 as a document tray on which a document is to be placed. The scanner 2 also include a light source 21, an imaging lens 22, and an image sensor 23 as a reader such as a charge coupled device (CCD). The light source 21 is disposed directly below the exposure glass 20, and irradiates a document with light while moving. The imaging lens 22 focuses reflected light from the document to create an image, and the image sensor 23 reads a document image is disposed in an imaging position. In addition, the scanner 2 includes a plurality of mirrors that guide the reflected light from the document to the imaging lens 22 while reflecting.

A pressure plate 24 that presses down a document placed on the exposure glass 20 is arranged in an upper portion of the scanner 2. An automatic document feeder (ADF) that automatically feeds a document to the exposure glass 20 may be arranged instead of the pressure plate 24.

The image forming device 3 includes four image forming units 11Y, 11C, 11M, and 11K for four colors of toners that are yellow, cyan, and magenta of three primary colors and black. The image forming device 3 also includes a writing unit 34 as an exposure device that writes a latent image on each of photoconductor drums 7Y, 7C, 7M, and 7K that are latent image bearers described below. The writing unit 34 is disposed below the four image forming units 11Y, 11C, 11M, and 11K. In addition, the image forming device 3 includes four toner bottles 31Y, 31C, 31M, and 31K that store new toners for the respective image forming units 11Y, 11C, 11M, and 11K. The image forming device 3 also includes a transfer unit 32 as a transfer device, and a fixing unit 33. After toner images formed by the respective image forming units 11Y, 11C, 11M, and 11K are once transferred, the transfer unit 32 transfers the toner images to a sheet. The fixing unit 33 fixes the toner images on the sheet.

The image forming units 11Y, 11C, 11M, and 11K are arranged in the order of yellow, cyan, magenta, and black from an upstream side along a movement direction (indicated by an arow Xa in FIG. 1) of an outer circumferential surface of an intermediate transfer belt 32a that is an intermediate transferor described blow. The image forming units 11Y, 11C, 11M, and 11K include the respective photoconductor drums 7Y, 7C, 7M, and 7K to be rotated clockwise in a front view. In addition, charging members 62 as chargers, development units 30Y, 30C, 30M, and 30K, and cleaning devices 61 are arranged around the respective photoconductor drums 7Y, 7C, 7M, and 7K.

The charging members 62 perform charging processes on outer circumferential surfaces of the respective photoconductor drums 7Y, 7C, 7M, and 7K to uniformly charge the outer circumferential surfaces of the photoconductor drums 7Y, 7C, 7M, and 7K. The development units 30Y, 30C, 30M, and 30K render electrostatic latent images formed on the respective photoconductor drums 7Y, 7C, 7M, and 7K by the writing unit 34 visible with toner. Herein, each of the electrostatic latent images is rendered visible with toner as a single-color toner image. The cleaning devices 61 clean and collet residual transfer toner remaining on the outer circumferential surfaces of the respective photoconductor drums 7Y, 7C, 7M, and 7K even after the transfer.

The writing unit 34 includes a polygonal mirror and an fθ lens. The writing unit 34 scans while emitting a laser beam from a laser emitting device based on image information input from a device such as an external scanner, a personal computer (PC), and the scanner 2. The uniformly charged outer circumferential surfaces of the photoconductor drums 7Y, 7C, 7M, and 7K are selectively exposed to the laser beam, so that a surface potential on an area irradiated with the laser beam is reduced. Thus, electrostatic latent images are formed on the photoconductor drums 7Y, 7C, 7M, and 7K.

The toner bottles 31Y, 31C, 31M, and 31K are individually filled with new toners of the respective four colors. The toners inside the toner bottles 31Y, 31C, 31M, and 31K are supplied to the respective development units 30Y, 30C, 30M, and 30K of the image forming units 11Y, 11C, 11M, and 11K via supply paths.

The transfer unit 32 includes the intermediate transfer belt 32a as an intermediate transferor. The intermediate transfer belt 32a is an endless belt having a multi-layer structure of elastic resin. The intermediate transfer belt 32a is supported by and looped around a plurality of rollers (i.e., the intermediate transfer belt 32a extends across a plurality of rollers in a state in which tension is applied). Particularly, the intermediate transfer belt 32a is supported by and looped around four support rollers 32b, 32c, 32d, and 32e, four primary transfer rollers 32f, and a secondary transfer roller 32g.

The support roller 32b (hereinafter referred to as a drive roller 32b) serves as a drive roller connected to a driver, and has a function of rotating the intermediate transfer belt 32a in a direction indicated by an arrow Xa. The secondary transfer roller 32g is arranged (i.e., disposed or positioned) in a position opposite the support rollers 32b with the intermediate transfer belt 32a therebetween. A cleaning device 32h is disposed near the support roller 32c. The cleaning device 32h cleans an outer circumferential surface of the intermediate transfer belt 32a by scraping the remaining toner attached to the outer circumferential surface of the intermediate transfer belt 32a.

In consideration of image degradation due to void area electric discharge, the primary transfer rollers 32f are arranged in positions slightly shifted downstream in a conveyance direction of the intermediate transfer belt 32a from directly-facing positions in which the primary transfer rollers 32f contact the respective photoconductor drums 7Y, 7C, 7M, and 7K with the intermediate transfer belt 32a therebetween with shortest center-to-center distances. Each of the primary transfer rollers 32f functions as a transfer bias (a transfer voltage) application device employing a contact application method. Particularly, each of the primary transfer rollers 32f is connected to a bias power source, and can apply a primary transfer bias (i.e., can apply a voltage) from a back surface (an inner circumferential surface) of the intermediate transfer belt 32a.

In an outer circumference of the drive roller 32b, the secondary transfer roller 32g is pressed against the intermediate transfer belt 32a by being urged by an urging device such that a secondary transfer nip is formed between the secondary transfer roller 32g and the drive roller 32b. The drive roller 32b serves as a contact-type transfer bias application device connected to a bias power supply. Alternatively, the secondary transfer roller 32g may serve as a transfer bias application device. In such a case, the secondary transfer roller 32g applies a transfer bias having a polarity opposite to a toner image to be transferred.

The fixing unit 33 includes a fixing belt 33c and a pressure roller 33d as a pressure rotator. The fixing belt 33c is an endless belt that extends across a fixing roller 33a and a heating roller 33b. The pressure roller 33d is pressed against the fixing belt 33c (i.e., the pressure roller 33d is brought into pressure contact with the fixing belt 33c), so that a fixing nip is formed between the pressure roller 33d and the fixing belt 33c. In the fixing unit 33, heat and pressure are applied to the sheet conveyed through the sheet conveyance path 6, and the toner image transferred in the secondary transfer nip of the transfer unit 32 is fused and fixed on the sheet.

The sheet feeder 4 includes sheet trays 40 and 41 that can be pulled out from the apparatus body 10, and feed rollers 42 and 43. The sheet cassettes 40 and 41 store predetermined paper as sheets, and the feed rollers 42 and 43 are pressed from above with predetermined pressure against the sheets stored in the respective sheet cassettes 40 and 41. Sizes of the sheets respectively stored in the sheet cassettes 40 and 41 are different. The sheet feeder 4 feeds the sheet stored in each of the sheet cassettes 40 and 41 to the sheet conveyance path 6 by using each of the respective feed rollers 42 and 43.

The sheet feeder 4 also includes a manual feed tray 44 on which optional paper having a size within a range of predetermined conveyable size is placed, and a feed roller 45 that feeds the optional paper. The sheet feeder 4 feeds the paper placed on the manual feed tray 44 to the sheet conveyance path 6 by rotating the feed roller 45.

The internal output unit 5 includes an output tray 5a that is formed of a slant face on the apparatus body 10 in a lower portion of the sheet output space 12 between the toner bottles 31Y, 31C, 31M, and 31K and the scanner 2. In addition, the internal output unit 5 includes an output roller pair 5b that outputs (ejects) a sheet that has passed through the fixing unit 33 to the output tray 5a from the sheet conveyance path 6. Accordingly, the color copier 1 of the present embodiment includes an internal-output-type output unit having a function of causing sheets output by the internal output unit 5 to be stacked on the output tray 5a.

The sheet conveyance path 6 includes a normal conveyance path 6a employing a vertical conveyance method (a vertical path method) by which a sheet is conveyed upward from the sheet feeder 4 disposed in a lower portion of the apparatus body 10 toward the internal output unit 5 disposed in an upper portion of the apparatus body 10. In addition, the sheet conveyance path 6 includes a reverse conveyance path 6b in which a sheet is reversed for duplex printing. Such conveyance paths can be switched by a switching claw 6c, and the use of the switching claw 6c guides a sheet to the reverse conveyance path 6b. The sheet guided to the reverse conveyance path 6b is conveyed by a reverse conveyance roller pair 6d to an upper portion 6e that is arranged above the reverse conveyance path 6b. Subsequently, the reverse conveyance roller pair 6d is reversed, so that the sheet is reversed in a switchback manner. Then, the reversed sheet is conveyed to the normal conveyance path 6a short of a registration roller pair 6f.

In the normal conveyance path 6a and the reverse conveyance path 6b, there is a plurality of conveyance roller pairs that are spaced apart at a distance corresponding to a minimum sheet size. The plurality of conveyance roller pairs rotates while nipping a sheet, thereby conveying the sheet. In the normal conveyance path 6a, the registration roller pair 6f is disposed below the secondary transfer nip. The registration roller pair 6f adjusts a time to convey the sheet to the secondary transfer nip based on an instruction from a controller.

In FIG. 1, a waste toner container 18 is disposed on the left side of the sheet tray 40. The waste toner container 18 stores waste toners removed by the cleaning devices 61 of the respective image forming units 11Y, 11C, 11M, and 11K, and a waste toner removed by the cleaning device 32h of the transfer unit 32.

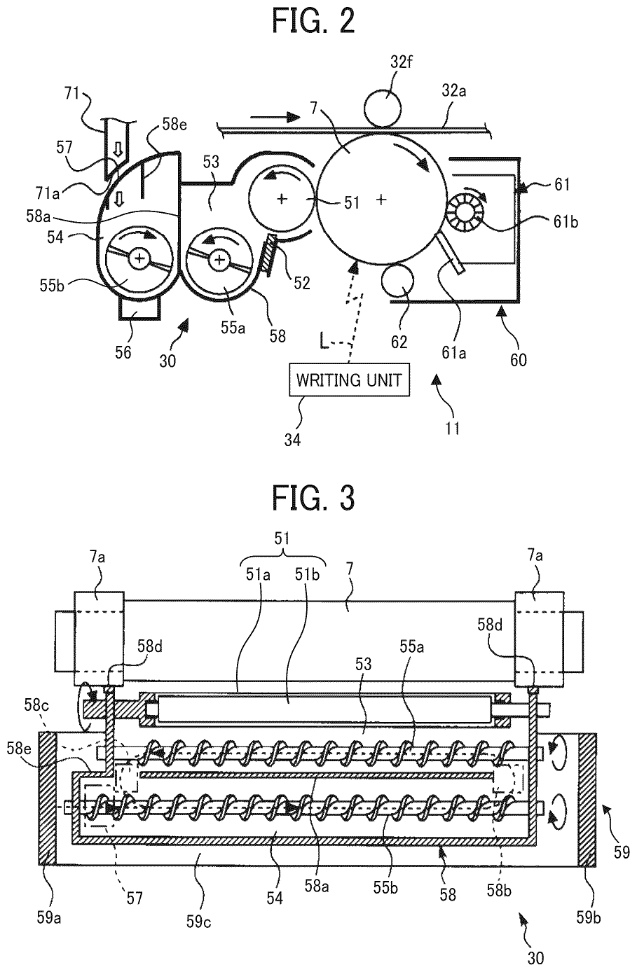

FIG. 2 is a diagram schematically illustrating a configuration of one of the four image forming units 11Y, 11C, 11M, and 11K, and FIG. 3 is a diagram illustrating one of the four development units 30Y, 30C, 30M, and 30K and one of the four photoconductor drums 7Y, 7C, 7M, and 7K in a longitudinal direction. In the present disclosure including the drawings, since the four image forming units 11Y, 11C, 11M, and 11K are substantially similar to every other except for the color of toner to be used, alphabetical codes Y, M, C, and K used for components such as the image forming units 11Y, 11C, 11M, and 11K, the development units 30Y, 30C, 30M, and 30K, toner concentration sensors 56Y, 56M, 56C, and 56K, and photoconductor units 60Y, 60M, 60C, and 60K may be omitted for the sake of simplicity. The image forming unit 11 includes the photoconductor drum 7 as a latent image bearer, a photoconductor unit 60, and the development unit 30. The photoconductor unit 60 includes the charging member 62, the cleaning device 61, and a discharge unit that are arranged around the photoconductor drum 7. Each of the photoconductor unit 60 and the development unit 30 is detachable from the apparatus body 10. The image forming unit 11 performs image forming processes (a charging process, an exposure process, a development process, a transfer process, and a cleaning process) on the photoconductor drum 7, so that an image of each color is formed on the photoconductor drum 7.

In FIG. 2, the photoconductor drum 7 is rotated clockwise by a drive motor. A charging bias is applied to the charging member 62, so that a surface of the photoconductor drum 7 is uniformly charged (the charging process). Subsequently, the surface of the photoconductor drum 7 reaches an exposure position in which the writing unit 34 as an exposure device irradiates the surface of the photoconductor drum 7 with a laser beam L. In this position, the writing unit 34 forms an electrostatic latent image of the corresponding color by exposure scanning (the exposure process). Then, the surface of the photoconductor drum 7 reaches a position opposite the development unit 30. In this position, the development unit 30 develops the electrostatic latent image to form a toner image of the corresponding color (the development process). Subsequently, in a primary transfer portion that is arranged opposite the primary transfer roller 32f with the intermediate transfer belt 32a therebetween, the toner image on the surface of the photoconductor drum 7 is transferred to the intermediate transfer belt 32a (a primary transfer process). The toner images of different colors formed on the respective photoconductor drums 7 are transferred on the intermediate transfer belt 32a in an overlapping manner, thereby forming a color image on the intermediate transfer belt 32a. The cleaning device 61 includes a cleaning brush roller 61b and a cleaning blade 61a, and a residual transfer toner remaining on an outer circumferential surface of the photoconductor drum 7 even after the transfer is removed by the cleaning brush roller 61b and the cleaning blade 61a.

Next, a configuration and an operation of the development unit 30 is further described in detail. The development unit 30 includes a development case 58 and a base member 59 that rotatably holds the development case 58. The development case 58 contains a development roller 51 disposed opposite the photoconductor drum 7, a doctor blade 52 disposed opposite the development roller 51, and two conveyance screws 55a and 55b respectively arranged inside a first developer container 53 and a second developer container 54. Moreover, a toner concentration sensor 56 is attached to the development case 58. The toner concentration sensor 56 detects a toner concentration in the developer of the first developer container 53.

The development roller 51 is disposed opposite the photoconductor drum 7 with a small gap therebetween such that a developing region is formed. The development roller 51 includes a magnet 51b having a plurality of magnetic poles fixedly installed inside, and a sleeve 51a that rotates around the magnet 51b. The first and second developer containers 53 and 54 store a two-component developer containing carrier and toner. The second developer container 54 includes a toner supply inlet 57 that is formed in an upper portion of the second developer container 54.

The sleeve 51a of the development roller 51 has an outer circumferential surface with a plurality of recesses formed by a sandblasting process or a plurality of V-grooves. The sleeve 51a is rotated in a direction (a counterclockwise direction) indicated by an arrow illustrated in FIG. 2. The developer carried on the development roller 51 by a magnetic field formed by the magnet 51b moves on the development roller 51 with the rotation of the sleeve 51a. The developer inside the development unit 30 is adjusted such that a toner ratio (a toner concentration) in the developer falls within a predetermined range. The toner stored in the toner bottle 31 is supplied to the development case 58 via the toner supply inlet 57 arranged in a toner supply unit 58e from a toner supply port 71a of a toner supply tube 71 of a toner supply device.

The first developer container 53 and the second developer container 54 are separated by a partition 58a, and both end portions of the first and second developer containers 53 and 54 communicate with each other via communication ports 58b and 58c. The first conveyance screw 55a supplies developer toward the development roller 51 while conveying the developer received from the second developer container 54 via the communication port 58b in a longitudinal direction, and collects post-development-process developer separated from the development roller 51. The second conveyance screw 55b agitates and mixes the post-development-process developer conveyed from the first developer container 53 via the communication port 58c and a fresh toner supplied from the toner supply inlet 57 while conveying the post-development-process developer and the fresh toner in the longitudinal direction. Accordingly, the developer inside the development case 58 circulates between the first and second developer containers 53 and 54 while being mixed and agitated by the first and second conveyance screws 55a and 55b.

The fresh toner in the developer supplied from the toner supply inlet 57 is absorbed to carrier by triboelectric charging between the carrier and the fresh toner, and the fresh toner and the carrier are carried on the development roller 51 by a magnetic force formed on the development roller 51. The developer carried on the development roller 51 reaches a position of the doctor blade 52.

After the doctor blade 52 regulates an amount of the developer on the development roller 51 to an appropriate amount, the developer is conveyed to the developing region which is a position opposite the photoconductor drum 7. A development bias is applied to a sleeve, so that a development electric field is formed between the sleeve and the photoconductor drum 7. In the developing region, the toner in the developer on a surface of the sleeve is suppled to a latent image on a surface of the photoconductor drum 7 by the development electric field, thereby developing the latent image on the photoconductor drum 7. Subsequently, the developer remaining on the development roller 51 reaches an upper portion of the first developer container 53 with rotation of the sleeve, and is then separated from the development roller 51.

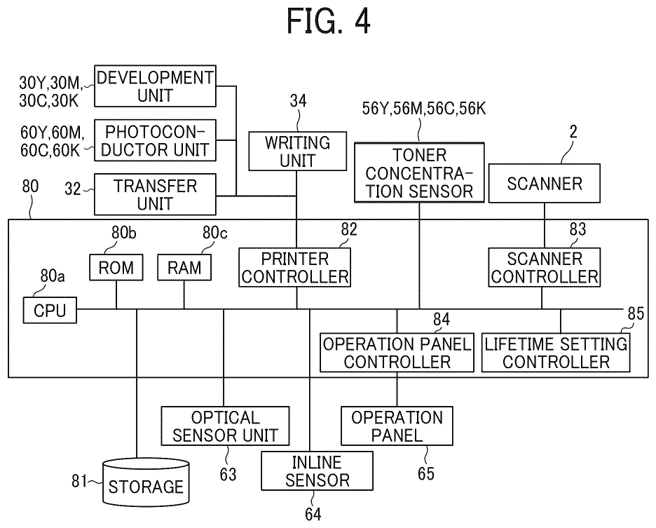

The toner concentration sensor 56 detects a toner concentration of the developer, and a result of the detection is transmitted as an electric signal to a central processing unit (CPU) 80a (see FIG. 4). The CPU 80a compares an output voltage from the toner concentration sensor 56 with a target voltage value Vtref stored in a storage 81 (see FIG. 4) that is a memory of the apparatus body 10, according to a predetermined control program stored in a read only memory (ROM) 80b or the storage 81. The target voltage value Vtref is a target value of an output voltage. The CPU 80a drives the toner supply device such that a toner amount corresponding to a result of the comparison is supplied from the toner supply inlet 57, and an appropriate amount of the toner is supplied to the developer inside the second developer container 54 from the toner bottle 31 (toner supply control).

According to the present embodiment, the target voltage value Vtref of the toner concentration sensor 56 is changed based on an image area rate in a predetermined period or an image density (a toner adhesion amount) of a detection toner patch formed for each predetermined number of sheets in continuous printing. An image density (a toner adhesion amount) of the detection toner patch is detected by an optical sensor unit 63 disposed opposite an outer circumferential surface of the intermediate transfer belt 32a illustrated in FIG. 1.

The development case 58 includes contact portions 58d that contact respective holders 7a that rotatably hold both sides of the photoconductor drum 7. The contact portions 58d contact the holders 7a, so that the development roller 51 is provided in a development position in which the development roller 51 is disposed opposite the photoconductor drum 7 with a predetermined gap therebetween.

The base member 59 includes a pair of face plates 59a and 59b and a connection portion 59c that connects the face plate 59a to the face plate 59b. The development case 58 is rotatably supported by the pair of face plates 59a and 59b of the base member 59. The rotation of the development case 58 moves the development roller 51 between the development position illustrated in FIG. 3 and a retracted position. In the development position, the development roller 51 is positioned opposite the photoconductor drum 7 with a predetermined gap therebetween. In the retracted position, the development roller 51 is retracted from the photoconductor drum 7.

When the development unit 30 or the photoconductor unit 60 is attached to or detached from the apparatus body 10, the development case 58 is rotated to move the development roller 51 from the development position to the retracted position. Particularly, the color copier 1 includes a rotation system that rotates the development case 58. When the development unit 30 or the photoconductor unit 60 is attached to or detached from the apparatus body 10, an operator operates the rotation system to rotate the development case 58 to move the development roller 51 to a retracted position. Accordingly, when the development unit 30 or the photoconductor unit 60 is attached to or detached from the apparatus body 10, a problem such as damage to the development unit 30 or the photoconductor unit 60 due to interference with the development roller 51 does not tend to occur.

FIG. 4 is a functional block diagram of the color copier 1. A controller 80 includes the CPU 80a, the ROM 80b, a random access memory (RAM) 80c, a printer controller 82, a scanner controller 83, an operation panel controller 84, and a lifetime setting controller 85 each of which is connected via a bus.

The CPU 80a starts an operating system (OS) by a boot program stored in the ROM 80b. Then, the CPU 80a executes a control program stored in the storage 81 or the ROM 80b on the OS to comprehensively control the color copier 1. For example, the CPU 80a executes a predetermined control program to perform the toner supply control described above and image density adjustment control.

The RAM 80c is used as a main memory or a temporary storage area such as a work area of the CPU 80a. The storage 81 as a memory is a readable writable nonvolatile memory such a hard disk drive (HDD). In the storage 81, a program for comprehensively controlling the color copier 1, various application programs, data for managing consumable parts, and various data are stored. An example of the various data includes a moving image demonstrating a series of operations necessary for resolving a maintenance event.

The printer controller 82 functions as an interface so that the CPU 80a controls each printer-related hardware such as the development unit 30, the photoconductor unit 60, the sheet feeder 4, the writing unit 34, and the fixing unit 33. The scanner controller 83 functions as an interface so that the CPU 80a controls the scanner 2.

An operation panel 65 includes an input unit as an input device such as a touch panel and hard keys that receive an operation instruction from a user, and a display such as a liquid crystal display (LCD) and a cathode ray tube (CRT). The operation panel controller 84 functions as an interface so that the CPU 80a controls the operation panel 65.

An inline sensor 64, as illustrated in FIG. 1, is disposed between the switching claw 6c and the output roller pair 5b. The inline sensor 64 reads an image formed on the sheet. The switching claw 6c switches a destination of a sheet having passed through the fixing unit 33.

The lifetime setting controller 85 has a function of causing the CPU 80a to execute a predetermined program to perform a series of control operations for setting a lifetime of a replacement reuse development unit that has been attached. Particularly, the CPU 80a detects development unit replacement, and detects whether a replacement development unit 30 that has been attached is a new item or a reuse item. If the replacement development unit is a reuse item, the CPU 80a estimates a degradation state of the development unit 30. Moreover, the CPU 80a sets a lifetime of the replacement reuse development unit based on the estimated degradation state of the development unit 30.

The CPU 80a executes a predetermined program to performs lifetime determination control on each of the development units 30Y, 30C, 30M, and 30K. Particularly, the CPU 80a counts the number of sheets that have been printed since the replacement of the development unit. If the cumulative number of printed sheets reaches a lifetime sheet quantity that has been set, the CPU 80a determines that the development unit has reached the end of its lifetime. Accordingly, the CPU 80a displays an instruction on the operation panel 65 such that the development unit the lifetime of which has been reached is to be replaced. In addition, when the cumulative number of printed sheets approaches the set lifetime sheet quantity, the CPU 80a displays a message indicating that there is a development unit that is to reach the end of its lifetime on the operation panel 65, and prompts a service center to arrange replacement of the development unit. Alternatively, the CPU 80a notifies a service center via an Internet line of a message indicating that there is a development unit 30 that approaches its lifetime.

Particularly, the average number of printed sheets per day is calculated from daily printing operations, and the number of days remaining until the development unit reaches its lifetime is calculated from the calculated average number of printed sheets per day and a difference between a lifetime sheet quantity that has been set and the cumulative number of printed sheets since replacement of the development unit. If the number of remaining days is less than a remaining day threshold value, the CPU 80a determines that the development unit approaches the end of its lifetime. Accordingly, the CPU 80a displays a warning that the development unit approaches the end of its lifetime on the operation panel 65 or notifies a service center of a message indicating that there is a development unit that approaches the end of its lifetime.

In recent years, reuse and recycle are encouraged in the electrophotographic field by penetration of ideas such as Sustainable Development Goals (SDGs). Although market products are returned each day due to various reasons, a development unit 30 inside the apparatus is often returned even in a state in which the development unit 30 has a remaining lifetime. In a hardware viewpoint, the returned development unit 30 can be used again depending on a reason for return as long as a failure of the development unit 30 or the end of lifetime of the development unit 30 is not a reason for return. In a case where the returned development unit 30 having a remaining lifetime is reused, a high-cost component such as carrier and a development roller is used as is, whereas a low-cost component such as a seal and a filter is replaced. Thus, a reuse development unit 30 can be provided at low cost. However, since a functional component such as carrier and a development roller directly affects a lifetime of the development unit, the use of the high-cost component such as carrier and a development roller as is causes variations in lifetime of a reuse development unit. In a case where a new development unit is used, control is performed based on the premise that the new development unit has a lifetime of 100%. On the other hand, in a case where a reuse development unit is used, control needs to be performed based on a lifetime corresponding to the reuse development unit. The reuse item can also be called a used item or a recycled item.

According to the present embodiment, as described above, a lifetime is determined based on the cumulative number of sheets printed since replacement of the development unit, so that a user or a service person can be notified when the development unit approaches the end of its lifetime. In a case where such lifetime determination is to be performed, a lifetime of the development unit needs to be ascertained beforehand with high accuracy.

In the present embodiment, therefore, when a development unit is replaced with a reuse development unit (when a reuse development unit is attached to the color copier 1 for the first time), control for estimating a degradation state is performed on the replacement reuse development unit. Then, a lifetime sheet quantity is set based on the estimated degradation state. Hereinafter, characteristics of the present embodiment are specifically described.

First, a description is given of detection of replacement of a development unit and detection of reuse item/new item. For example, a nonvolatile memory is disposed on a substrate of the toner concentration sensor 56, and detection of replacement of a development unit and detection of reuse item/new item can be detected from information stored in the nonvolatile memory.

FIG. 5 is a functional block diagram illustrating one example of the toner concentration sensor 56. The toner concentration sensor 56 includes a CPU 116 and an input output (I/O) port 117, and the CPU 80a in the apparatus body 10 of the color copier 1 communicates with the CPU 116 and the I/O port 117 according to a communication protocol compliant with International Organization for Standardization (ISO) 7816. The CPU 116 communicates with the CPU 80a in the apparatus body 10 based on a program stored in a ROM 119, and reads from and writes in an electrically erasable programable read only memory (EEPROM) 121 based on an instruction from the CPU 80a in the apparatus body 10. The EEPROM 121 is a nonvolatile memory. The I/O port 117 is a communication interface circuit compliant with ISO 7816-3. A system controller 118 is a circuit that controls the inside of an integrated circuit (IC) chip. The ROM 119 is a program memory, and a RAM 120 is a working memory for execution of a program. The EEPROM 121 as a memory is a nonvolatile memory. An E-EEPROM 122 is a memory in which a dedicated instruction for writing data into the EEPROM 121 is stored.

In the EEPROM 121, any of “new item”, “reuse item” and “attached item” information is stored in addition to color of developer, a type of developer, and a serial number. In the present disclosure, the terms “new item” and “reuse item” may also be expressed as “new” and “reuse”, respectively.

Any of the “new item”, “reuse item” and “attached item” information is stored at a predetermined memory address of the EEPROM 121. For example, if a development unit is a “new item” that has not been attached to an apparatus body even once since shipment, a code “01h” is stored at the memory address. On the other hand, if a development unit is a “reuse item” that has been used once in another copier, returned to a manufacturer for maintenance, and then shipped out again, a code “02h” is stored at the memory address. The information in the EEPROM 121 is rewritten to “reuse item” when the maintenance work is performed in a recycling plant to reship the development unit as a reuse item.

If a development unit is an “attached item” that has been attached to the color copier 1 once, a code “00h” is stored at the memory address. The information in the EEPROM 121 is rewritten to “attached item” when a replacement initial operation is finished. The replacement initial operation is performed when a development unit is replaced.

The apparatus body 10 has an opening through which the development unit 30 is attached and detached. When the CPU 80a of the apparatus body 10 detects that, for example, the opening of the apparatus body 10 is opened and closed, the CPU 80a transmits an instruction to the CPU 116 of the toner concentration sensor 56. That is, the CPU 80a instructs the CPU 116 to read the information at the memory address of the EEPROM 121 in which any of the “new item”, “reuse item” and “attached item” information is stored.

The CPU 116 of the toner concentration sensor 56 reads the information at the memory address of the EEPROM 121 based on the instruction, and transmits the read information to the CPU 80a of the apparatus body 10 via the I/O port 117. The CPU 80a of the apparatus body 10 detects whether the development unit being attached is a “new item”, “reuse item”, or “attached item” based on the information received from the toner concentration sensor 56. The information received herein is the information at the memory address. If the received information at the memory address is “01h (new item)” or “02h (reuse item)”, the CPU 80a determines that the development unit has been replaced, and executes a replacement initial operation described below.

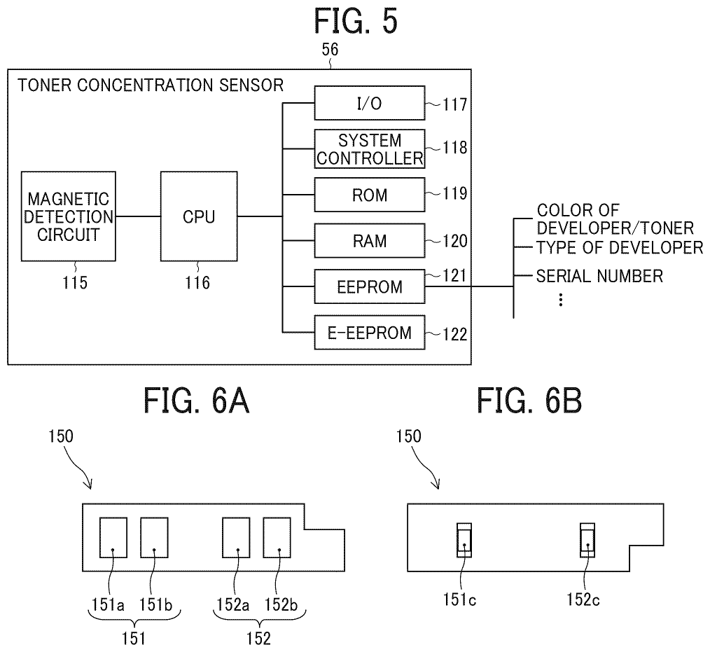

Alternatively, a detection substrate for detecting a “new item”, “reuse item”, or “attached item” may be used to detect that a development unit that has been attached to an apparatus body is a “new item”, “reuse item”, or “attached item”. FIGS. 6A and 6B are diagrams illustrating one example of a detection substrate 150 for detecting a “new item”, “reuse item”, and “attached item”. FIG. 6A illustrates a front surface of the detection substrate 150, and FIG. 6B illustrates a back surface of the detection substrate 150.

The detection substrate 150 includes a first circuit 151 that is a first electric circuit for detecting whether a development unit is a “new item”, and a second circuit 152 that is a second electric circuit for detecting whether a development unit is a “reuse item”. The first circuit 151 includes electrode portions 151a and 151b that contact respective connection terminals of the apparatus body 10 and a fuse attachment portion 151c to which a fuse is attached. The second circuit 152 includes electrode portions 152a and 152b that contact respective connection terminals of the apparatus body 10 and a fuse attachment portion 152c to which a fuse is attached. The electrode portions 151a and 151b of the first circuit 151 and the electrode portions 152a and 152b of the second circuit 152 are arranged on the front surface of the detection substrate 150 as illustrated in FIG. 6A, whereas the fuse attachment portions 151c and 152c are arranged on the back surface of the detection substrate 150 as illustrated in FIG. 6B.

If the development unit is a “new item”, an energizable fuse is attached to the fuse attachment portion 151c of the first circuit 151. If the development unit is a “reuse item”, an energizable fuse is attached to the fuse attachment portion 152c of the second circuit 152. During maintenance work at a recycling plant in preparation for reshipping the development unit as a reuse item, a detection substrate attached to the development unit is replaced with a detection substrate on which a fuse is attached to the fuse attachment portion 152c of the second circuit 152.

When the development unit 30 is attached to the apparatus body 10 of the color copier 1, the connection terminals arranged in the apparatus body 10 contact the respective electrode portions 151a, 151b, 152a, and 152b. Thus, voltage can be applied to the first circuit 151 and the second circuit 152.

For example, when the CPU 80a of the apparatus body 10 detects that an opening of the apparatus body 10 to and from which the development unit 30 is attached and detached is closed, voltage is applied to each of the first circuit 151 and the second circuit 152.

In a case where a development unit attached to the apparatus body 10 is a “new item”, the first circuit 151 is energized as the energizable fuse is attached to the first circuit 151. On the other hand, the second circuit 152 is not energized as a fuse is not attached. Accordingly, if energization of only the first circuit 151 is confirmed, the CPU 80a detects that the development unit attached to the apparatus body 10 is a “new item”. Subsequent to the detection of “new item”, the fuse is blown and shifted to an insulated state. Particularly, after the replacement initial operation is finished with respect to the development unit of “new item”, the fuse is blown and shifted from an energizable state indicating a new item to an insulated state indicating a state subsequent to the beginning of use.

In a case where a development unit attached to the apparatus body 10 is a “reuse item”, the first circuit 151 is not energized as a fuse is not attached, whereas the second circuit 152 is energized as an energizable fuse is attached. Accordingly, if energization of only the second circuit 152 is confirmed, the CPU 80a detects that the development unit attached to the apparatus body 10 is a “reuse item”. Subsequent to the detection of “reuse item”, an electrical state is shifted as similar to the aforementioned case of “new item”. After the replacement initial operation is finished, the fuse is blown and is shifted from an energizable state indicating a reuse item to an insulated state indicating a state subsequent to the beginning of use.

On the other hand, in a case where a development unit is attached once, and a fuse of the first circuit 151 or the second circuit 152 is in an insulated state, both of the first circuit 151 and the second circuit 152 are not energized. Thus, in a case where energization of both the first circuit 151 and the second circuit 152 is not confirmed, the CPU 80a detects that the attached development unit is an “attached item”.

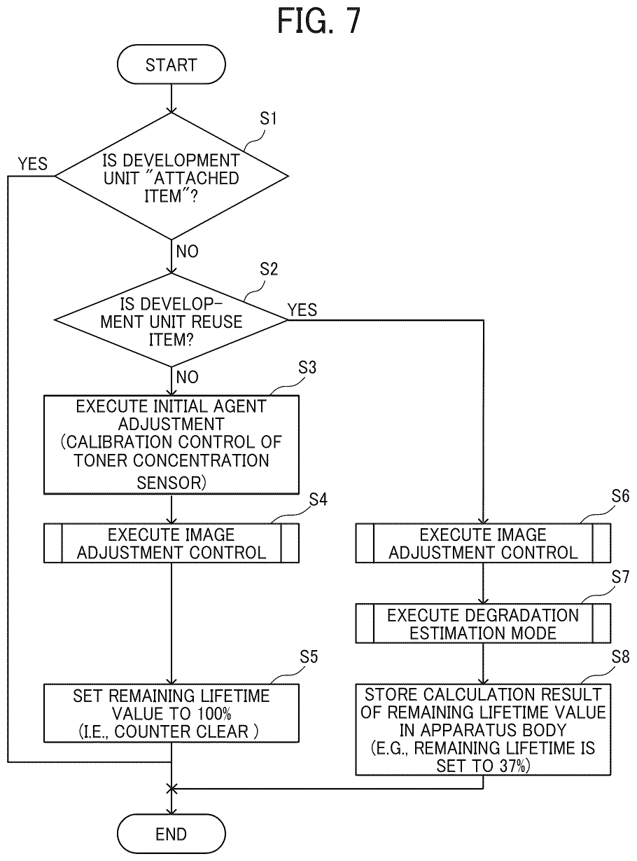

Next, a description is given of the replacement initial operation which is executed when a development unit is replaced with a “new item” or “reuse item”. FIG. 7 is a flowchart illustrating the replacement initial operation to be executed when a development unit is replaced with a “new item” or “reuse item”. The replacement initial operation illustrated in FIG. 7 is executed after the aforementioned “new item”, “reuse item”, or “attached item” is detected. In step S1, if a development unit 30 attached (being attached) to the apparatus body 10 is an “attached item” (YES in step S1), the operation ends without any process.

On the other hand, if a development unit 30 attached (being attached) to the apparatus body 10 is a “new item” (NO in step S1, NO in step S2), the operation proceeds to step S3 in which an initial agent adjustment is executed. The initial agent adjustment is a process for adjusting (calibrating) an output level of the toner concentration sensor 56. Particularly, an output of the toner concentration sensor 56 at the time when an initial agent has a toner concentration of 7 wt % is checked, and a voltage to be applied to a magnetic detection circuit 115 (see FIG. 5) is adjusted such that an output of the toner concentration sensor 56 becomes a predetermined reference output. The adjusted voltage value is stored in the EEPROM 121 of the toner concentration sensor 56.

When the initial agent adjustment is finished, the operation proceeds to step S4. In step S4, image adjustment control is executed. When the image adjustment control is executed, a development potential (=development bias−exposure potential on a photoconductor drum surface) is first changed, and a gradation pattern is formed as an image adjustment pattern on an intermediate transfer belt. The gradation pattern is formed of a plurality of toner patches each having a different image density. Then, the optical sensor unit 63 detects a toner adhesion amount (mg/cm²) of each toner patch of the gradation pattern on the intermediate transfer belt.

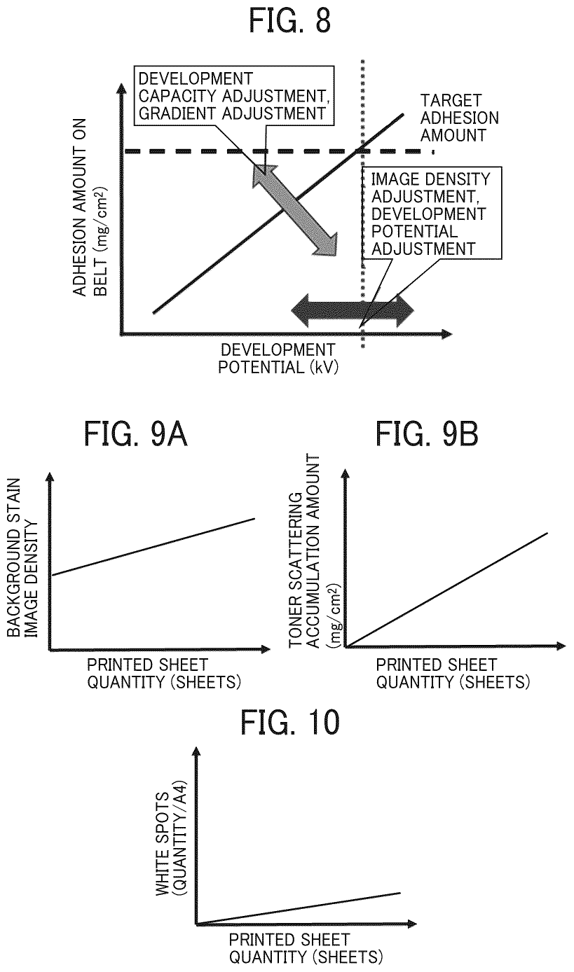

Next, as illustrated in FIG. 8, a relation between a detected toner adhesion amount of each toner patch and a development potential is linearly approximated to determine a relational expression represented by “y=ax+b”. Although a least-squares method can be used in the linear approximation, the method is not limited thereto. Next, a development capacity (development γ) that is a gradient of the linear function (y=ax+b) indicating the relation between the toner adhesion amount and the development potential is checked whether the development capacity falls in a target range. In a case where the development capacity (development γ) is excessively higher than the target range, an irregular image such as toner scattering and background stains fouling may be generated. In a case where the development capacity (development γ) is excessively lower than the target range, an irregular image of carrier adhesion (white spots) may be generated. Thus, in a case where the determined development capacity (development γ) is not a target value, toner is supplied to the development unit or toner is consumed to adjust the development capacity (development γ). In the present embodiment, the target range is set to 1.00±0.10 ([mg/cm²]/kV).

Particularly, in a case where a value of the determined development capacity is higher than the target range, a target voltage value Vtref of the toner sensor is changed to a lower value. Then, the toner in the developer inside the development unit is consumed by forming a pattern image for discharge, and a toner concentration of the developer is adjusted to the target value which has been changed. On the other hand, in a case where a value of the determined development capacity is lower than the target range, a target voltage value Vtref of the toner sensor for the developer to be controlled is changed to a higher value. Then, toner is supplied to the development unit, and a toner concentration of the developer is changed to the target value which has been changed.

Subsequently, image density adjustment is performed. The image density adjustment adjusts image forming conditions (a development bias, a charging bias, and an exposure amount) such that a target image density is obtained. Particularly, a development potential necessary to obtain a predetermined target adhesion amount is specified based on the determined relation between the toner adhesion amount and the development potential illustrated in FIG. 8. In a case where a development capacity is adjusted, a gradation pattern is formed again subsequent to the adjustment, and a relation between the toner adhesion amount and the development potential is redetermined.

A development bias is calculated based on the specified development potential. In addition, a charging bias is determined from the calculated development bias and a predetermined background potential (a difference between a potential of a background portion (a portion that is not exposed to light) of a photoconductor surface and a development bias potential: 150 [V] in the present embodiment). When the image density adjustment is finished, the operation proceeds to step S5. In step S5, the cumulative number of printed sheets for lifetime determination is reset to zero. The cumulative number of printed sheets herein is stored in the storage 81. That is, in step S5, a remaining lifetime value is set to 100%.

On the other hand, if the development unit 30 attached (being attached) to the apparatus body 10 is a “reuse item” (NO in step S1, YES in step S2), the operation proceeds to step S6. In step S6, image adjustment control is executed without execution of the above-described initial agent adjustment. If the development unit 30 is a reuse item, the development unit 30 has undergone the initial agent adjustment in a previous device, and a value of voltage to be applied to the magnetic detection circuit 115 (see FIG. 5) is stored in the EEPROM 121 of the toner concentration sensor 56. Thus, the initial agent adjustment is not executed. If the development unit 30 is a “new item”, the development unit 30 is filled with developer the toner concentration of which is adjusted to 7 wt %. However, if the development unit 30 is a “reuse item”, magnetic carrier that is previously used is poured, and then a predetermined amount of toner is poured. Consequently, a toner concentration may not always be 7 wt %. Accordingly, execution of the initial agent adjustment may cause misdetection.

Accordingly, after the image adjustment control is executed as similar to the case of “new item”, the development capacity is adjusted and the image forming conditions such as a development bias are adjusted. Then, in step S7, a degradation state estimation mode that estimates a degradation state is executed with respect to the development unit of the “reuse item”.

The background stains, the toner scattering, and the carrier adhesion become worse as the degradation of the development unit progresses. Thus, in the degradation state estimation mode according to the present embodiment, a state of the background stains or the toner scattering, or a state of carrier adhesion is detected to detect a degradation state of the “reuse” development unit.

Herein, a description is given of a mechanism in which the background stains or toner scattering becomes worse as the degradation of the development unit progresses. The outer circumferential surface of the sleeve 51a of the development roller 51 has a plurality of recesses formed by sandblasting process or a plurality of V grooves. Such recesses or V grooves are abraded over time, causing a decrease in an amount of developer to be supplied to the sleeve 51a. Such a decrease in the amount of developer to be supplied to the sleeve 51a decreases an image density.

In the present embodiment, the above-described image adjustment control is executed to adjust a target voltage value Vtref of the toner concentration sensor 56 such that development capacity falls within a target range. Since the decrease in the image density causes the development capacity to be lower than the target range, the target voltage value Vtref of the toner concentration sensor 56 increases. As a result, a toner concentration of the developer increases. When the toner concentration of the developer increases, a charge amount of the toner decreases. Moreover, a decline in ability to triboelectrically charge toner due to carrier degradation decreases a charge amount of the toner. Accordingly, the decrease in the charge amount of the toner weakens a Coulomb force between carrier and toner, and background stains and toner scattering tend to occur.

FIG. 9A is a graph illustrating a relation between a background stain image density and a printed sheet quantity (also referred to as the number of printed sheets). FIG. 9B is a graph illustrating a relation between an accumulated amount of scattered toner and a printed sheet quantity. As illustrated in FIG. 9A, the background stain image density linearly increases as the number of printed sheets increases. Moreover, as illustrated in FIG. 9B, the accumulated amount of scattered toner linearly increases as the number of printed sheets increases.

In the present embodiment as described above, the “reuse” development unit uses a high-cost component such as carrier and a development roller as is. Thus, detection of a state of the background stains or the toner scattering enables a degradation state of a “reuse item” (a degradation state of the sleeve of the development roller and a degradation state of carrier) at the time of replacement to the “reuse” development unit to be detected with good accuracy.

Next, a description is given of a mechanism in which carrier adhesion becomes worse as the degradation of the development unit progresses. The carrier includes a magnetic core coated with resin. However, the resin with which the core is coated is abraded over time, and an electric resistance of the carrier becomes smaller. Accordingly, the carrier is negatively charged by a development electric field in a developing region, and carrier adhesion in which carrier adheres to an irradiated area of the photoconductor drum occurs. In a case where the carrier adhesion occurs, white spots are generated on an image on a sheet.

FIG. 10 is a graph illustrating a relation between a quantity of white spots to be generated in an image with adhesion of carrier and the number of printed sheets. A quantity of white spots is also referred to as the number of white spots. As illustrated in FIG. 10, the number of white spots linearly increases as the number of printed sheets increases. In the present embodiment, carrier is used as is without replacement in the “reuse” development unit. Accordingly, detection of a quantity of white spots which appear on the image enables a degradation state of the “reuse item” (a degradation state of the carrier) at the time of replacement to the “reuse” development unit to be detected with good accuracy.

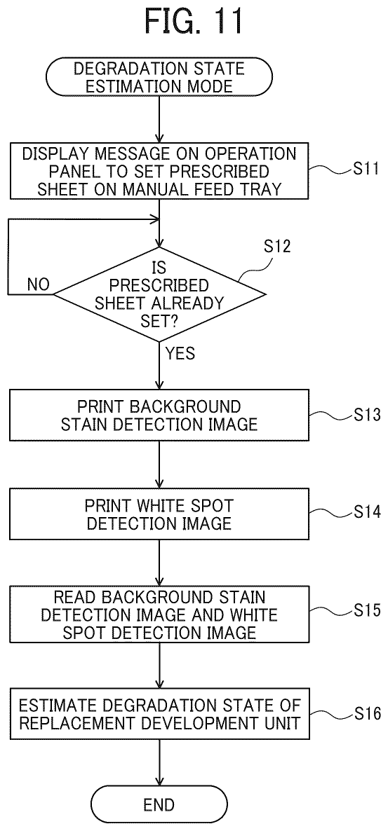

FIG. 11 is a flowchart illustrating a procedure performed in a degradation state estimation mode. In step S11, a message indicating that prescribed sheets supplied with a “reuse” development unit 30 packed in a packing box are to be set in the manual feed tray 44 is displayed on the operation panel 65 (see FIG. 4). A brand of paper type needs to be set; otherwise, an image density for the paper per se cannot be set, and subsequent control cannot be accurately performed.

An operator sets the prescribed sheets in the manual feed tray 44 and presses a “setting completion button” displayed on the operation panel 65, so that a state in which the prescribed sheets are already set is detected (YES in step S12). Subsequently, in step S13, a background stain detection image as a degradation state detection image on which background stains appear is printed for color of the replacement “reuse” development unit. This background stain detection image can be obtained by blank page printing under image forming conditions that background stain development sensitivity that worsens with progress of degradation of the development unit is enhanced (a background stain image density is increased).

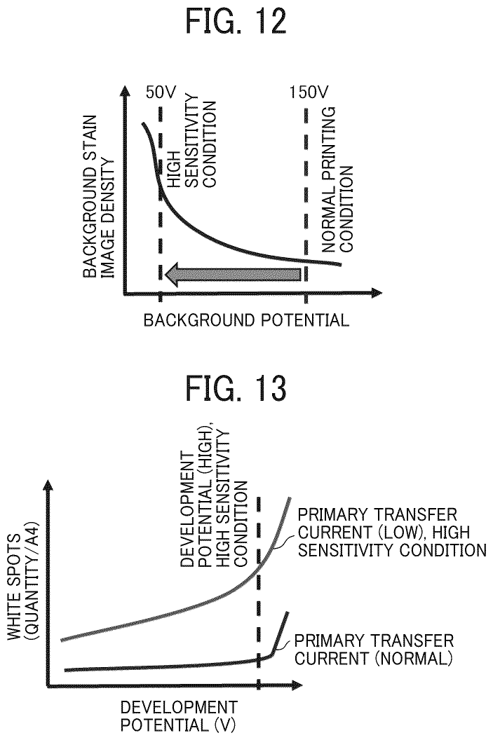

FIG. 12 is a graph illustrating a relation between a background image density and a background potential. As illustrated in FIG. 12, a decrease in the background potential (a difference between a potential of a background portion (a potion not exposed to light) of a photoconductor surface and a development bias potential) enhances sensitivity with respect to the background stain development which worsens with progress of degradation of the development unit. Accordingly, the background stains can appear on a prescribed sheet. In the present embodiment, the background potential is changed from a predetermined background potential (150 [V]) at the time of normal printing to 50 [V], and then a blank image is printed. In particularly, at least one of the development bias and the charging bias is changed from the value that has been adjusted by the aforementioned image adjustment control to change the background potential to 50 [V], and a background stain detection image is printed (a blank sheet is printed) with exposure turned off. Each of a primary transfer condition and a secondary transfer condition is the same condition as that at the time of normal printing. The background potential which is set at the time of printing the background stain detection image is one example, and can be set appropriately by a machine.

In a case where color of the replacement “reuse” development unit is yellow, magenta, or cyan, a background stain detection image is printed (blank sheet printing) in a state in which the intermediate transfer belt is in contact with all of the photoconductor drums. Herein, as for the colors other than the color of the replacement “reuse” development unit, a charging bias and a development bias are applied such that a background potential (150 V) at the time of normal printing is obtained to prevent color mixture of background stains due to transfer of background stain toners the colors of which are other than the color of the replacement “reuse” development unit.

Moreover, in a case where a plurality of development units are replaced with a plurality of replacement “reuse” development units 30 at the same time, a background potential is changed for each color, and a blank image is printed on a sheet. For example, in a case where development units for cyan and magenta are replaced with “reuse” development units at the same time, a background potential for cyan is first changed, and a blank sheet is printed. Subsequent to the printing, the background potential for cyan is changed back to a predetermined background potential (150 V) at the time of normal printing. Then, a background potential for magenta is changed, and a blank sheet is printed.

As illustrated in FIG. 11, in step S14, a white spot detection image is printed subsequent to the printing of the background stain detection image (the printing of the blank sheet). The white spot detection image serves as a degradation state detection image in which carrier adhesion appears (white spots appear). Such a white spot detection image can be obtained by printing a solid image under an image forming condition that white spots tend to be generated.

FIG. 13 is a graph illustrating a relation between a quantity of generated white spots, a development potential, and a primary transfer current. As illustrated in FIG. 13, an increase in the development potential increases the quantity of white spots. In addition, the quantity of white spots in a case in which a primary transfer current is low is greater than that in a case in which a primary transfer current is high. An increase in the development potential strengthens a development electric filed in a developing region, and more carrier is negatively charged. As a result, there is more carrier to be developed (more carrier to adhere to an irradiated area potential of the photoconductor drum), causing an increase in the number of white spots.

Although the carrier which has adhered to the photoconductor drum is negatively charged, a negative charge amount of the carrier is smaller than that of toner. Accordingly, the carrier is not transferred in the primary transfer portion or a secondary transfer portion, and an area to which the carrier has adhered becomes a non-toner adhesion area. Such a non-toner adhesion area appears as a white spot on a sheet.

In the present embodiment, the primary transfer bias to be applied to the primary transfer roller has a current that is maintained constant. Thus, a reduction in the primary transfer current weakens the primary transfer electric field in the primary transfer portion, and a rate of primary transfer from the photoconductor drum to the intermediate transfer belt is reduced. As a result, the carrier having a smaller negative charge amount than toner is not primarily transferred to the intermediate transfer belt in most cases. This increases the number of white spots on a sheet.

For the white spots to appear on a prescribed sheet, a certain amount of toner needs to adhere to the prescribed sheet to generate a certain level of contrast between a color of the toner adhering to the prescribed sheet and a color of the prescribed sheet. In the present embodiment, a toner image is formed on the photoconductor drum under an image forming condition for a solid image. Accordingly, even if a primary transfer current is reduced in the primary transfer portion to reduce a transfer rate, a certain amount of toner is transferred to the intermediate transfer belt. Thus, an image to be formed on a prescribed sheet can have a certain image density, and a certain level of contrast can be generated between a color of the image formed on the prescribed sheet and a color of the prescribed sheet, so that white spots can be detected in a good manner.

In the present embodiment, a primary transfer current is set to 1 (−μA) from 50 (−μA), and a solid image is printed. This enables good contrast to be generated between a color of the prescribed sheet and the image formed on the prescribed sheet, and a white spot detection image allowing white spots to be detected in a good manner can be obtained. Vaues of the primary transfer current and the development potential to be changed can be appropriately set by a machine. In the present embodiment, the secondary transfer condition is the same as the second transfer condition at the time of normal printing.

Alternatively, since more white spots appear on the prescribed sheet if carrier is not eventually transferred to the prescribed sheet, the primary transfer condition may be set to the same condition at the time of normal printing, and the secondary transfer condition may be set to a condition by which a transfer rate is reduced relative to that at the time of normal printing. Even under such a condition, transfer of the carrier to a sheet can be reduced in the secondary transfer portion, and more white spots can appear on the sheet.

Moreover, in a case where a plurality of “reuse” development units 30 is replaced at the same time, a development potential and a primary transfer current are changed for each color, and a white spot detection image is formed on a prescribed sheet for each color to avoid color mixture even on a white spot detection image.

In step S15, the background stain detection image and the white spot detection image formed on the respective prescribed sheets are read by the inline sensor 64 as an image reader disposed short of the output roller pair 5b.

The prescribed sheet on which the background stain detection image is formed and the prescribed sheet on which the white spot detection image is formed can be output to the output tray 5a, and then these prescribed sheets can be set on the scanner 2. In such a case, the background stain detection image and the white spot detection image can be read by the scanner 2.

Alternatively, the background stain detection image and the white spot detection image can be captured by a device such as a smartphone, and the captured images of the background stain detection image and the white spot detection image can be transmitted to a color copier by email or via an application, so that background stain detection image data and white spot detection image data can be acquired. Accordingly, even a low-cost image forming apparatus in which the inline sensor 64 or the scanner 2 is not disposed can detect an image density of the background stain detection image and the number of white spots.

Since the inline sensor 64 is disposed in an output path of the color copier to read a background stain detection image and a white spot detection image before the background stain detection image and the white spot detection image are output to the output tray 5a, an event such as swapping of the images does not occur. Hence, a degradation state of the replacement “reuse item” can be ascertained with accuracy. Alternatively, an optional unit including the inline sensor 64 may be set in the internal output unit 5. In such a case, a background stain detection image and a white spot detection image are read by the inline sensor 64 disposed in the optional unit.

Subsequently, in step S16, a degradation state of the replacement “reuse item” is estimated based on the read background stain detection image and the read white spot detection image to estimate a remaining lifetime. First, an image density of the read background stain detection image is detected. A predetermined image process is performed on the read background stain detection image. For example, a process for enhancing contrast between a background stain toner adhering to a prescribed sheet and a surface color of the prescribed sheet is performed. Adhesion of a background stain toner to a surface of a prescribed sheet printed as a blank sheet changes a color tint of the prescribed sheet. The more the background stain toner, the greater the change in a color tint with respect to an original color tint of the prescribed sheet. Thus, lightness of the prescribed sheet changes (an image density of a background stain detection image increases, and thus a darker background stain detection image appears). Such a change in lightness of the prescribed sheet is detected as an image density of the background stain detection image. Since an amount of change in the lightness with respect to an amount of the background stain toner adhering to the prescribed sheet differs depending on Y, M, C, and K, for example, lightness that is detected using a predetermined correction coefficient is corrected, and an image density of the background stain detection image is calculated for each of Y, M, C, and K.

In the description above, an image density of the background stain detection image formed on the prescribed sheet is detected. However, an amount of toner adhesion to a background stain detection image on the intermediate transfer belt 32a may be detected by the optical sensor unit 63, and an image density of the background stain detection image may be determined based on the detected toner adhesion amount. In such a case, there is an advantage that a prescribed sheet is not necessary. On the other hand, formation of a background stain detection image on a predetermined prescribed sheet, and detection of an image density of the background stain detection image formed on the prescribed sheet can eliminate an influence on an image density detection result due to a state (e.g., filming and damage) of a surface of the intermediate transfer belt. Therefore, there is an advantage that an image density of the background stain detection image can be detected with good accuracy.

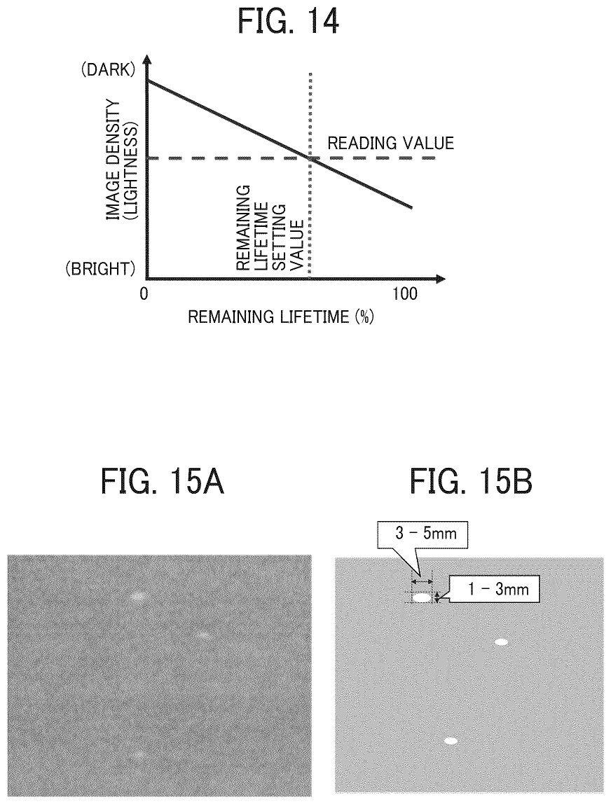

FIG. 14 is a graph illustrating one example of a relation between a calculated image density of a background stain detection image and a remaining lifetime. Since a relation between the number of printed sheets and the background stains is a proportional relation as previously illustrated in FIGS. 9A and 9B, a relation between a remaining lifetime and an image density of a background stain detection image the image density of which increases by an increase in background stain toner is a proportional relation as illustrated in FIG. 14. Accordingly, in a nonvolatile storage such as the ROM 80b or the storage 81 of the color copier 1, a linear function (Y1=aX1+b, where Y1 is an image density of a background stain detection image, and X1 is a remaining lifetime) indicating the relation between an image density of the background stain detection image and the remaining lifetime is stored. The remaining lifetime (%) of the replacement “reuse item” is estimated from the calculated image density and the linear function.

Herein, the remaining lifetime represents a degree of degradation relative to a development unit of a “new item”. A remaining lifetime of 100% represents that a development unit has a degradation state substantially the same as a degradation state of a “new” development unit (a state in which there is no degradation: a degree of degradation is 0%). A remaining lifetime of “0 %” represents that a development unit has a degree of degradation substantially the same as a degree of degradation in a case in which a “new development unit is used until “a lifetime printed sheet quantity” is reached (a degree of degradation is 100%).

A linear function for determining the remaining lifetime described above is, for example, determined as follows. That is, for a plurality of new development units, an image density of a background stain detection image is detected by the aforementioned method, and an average of the plurality of detected image densities is set as an image density at the time of a remaining lifetime of 100%. Moreover, for a plurality of development units each of which has reached a lifetime printed sheet quantity, an image density of a background stain detection image is detected by the aforementioned method, and an average of the plurality of detected image densities is set as an image density at the time of a remaining lifetime of 0%. Then, a linear function for determining the remaining lifetime described above is determined from the set image density at the time of the remaining lifetime of 100% and the set image density at the time of the remaining lifetime of 0%.

Subsequently, a remaining lifetime is calculated based on the read white spot detection image. A predetermined image process is first performed on the read white spot detection image. A process such as a process for enhancing contrast between a solid image formed on a prescribed sheet and a surface color of the prescribed sheet is performed on the solid image. Herein, the solid image to undergo the process has an image density that is lowered. FIG. 15A illustrates the read white spot detection image prior to the predetermined image process, FIG. 15B illustrates the white spot detection image subsequent to the predetermined image process. Based on comparison between FIGS. 15A and 15B, the image process increases a density difference between the white spots and the solid image having an image density which is lowered, and makes the white spots clear. When the white spots become clear by the image process, the number of white spots is detected by counting an image portion not only having an image density difference (a lightness difference) of a predetermined value or more but also having a size of a certain value or more. The image density difference herein is a lightness difference between the white spot and the solid image having an image density which is lowered.

The read white spot detection image can be converted into a black-and-white binarized image as the predetermined image process to be performed on the read white spot detection image, and the number of white spots can be detected based on the converted image data of the black-and-white binarized image,

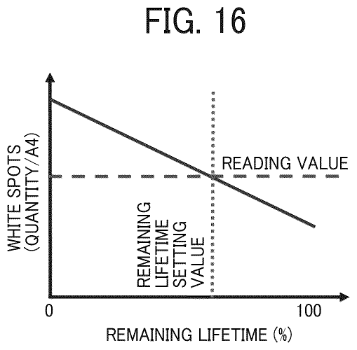

Upon detection of the number of white spots, a remaining lifetime is determined based on the number of white spots. FIG. 16 is a graph illustrating a relation between a quantity of detected white spots and a remaining lifetime (%). As described in FIG. 10, a relation between the number of printed sheets and the number of white spots is a proportional relation. Thus, as illustrated in FIG. 16, a relation between a quantity of white spots and a remaining lifetime is also a proportional relation. Accordingly, in a nonvolatile storage such as the ROM 80b or the storage 81 of the color copier 1, a linear function (Y2=cX2+d, where Y2 is the number of white spots, and X2 is a remaining lifetime) indicating a relation between a quantity of white spots and a remaining lifetime is stored. The remaining lifetime (%) is estimated from the number of detected white spots and the linear function.

The linear function for determining a remaining lifetime based on the number of white spots is determined as similar to the linear function for determining a remaining lifetime based on a background stain image density. That is, for a plurality of new development units, the number of white spots is detected by the aforementioned method, and an average of the plurality of detected white spot numbers is set as the number of white spots at the time of a remaining lifetime of 100%. Moreover, for a plurality of development units each of which has reached a lifetime printed sheet quantity, the number of white spots is detected by the aforementioned method, and an average of the plurality of detected white spot numbers is set as the number of white spots at the time of a remaining lifetime of 0%. Then, a linear function for determining the remaining lifetime is determined from the set number of white spots at the time of a remaining lifetime of 100% and the set number of white spots at the time of a remaining lifetime of 0%.

When the remaining lifetime based on the background stain image density and the remaining lifetime based on the number of white spots are determined, the degradation state estimation mode is finished. When the degradation state estimation mode is finished, in step S8 illustrated in FIG. 7, a lifetime of the replacement “reuse” development unit is set, and the set lifetime (the remaining lifetime) of the development unit is stored in the ROM 80b or the storage 81.

Particularly, a lifetime of the replacement “reuse” development unit is set based on the shorter of a remaining lifetime based on the background stain image density and a remaining lifetime based on the number of white spots. For example, a shorter remaining lifetime may be 37%. In such a case, a value corresponding to 37% of the lifetime sheet quantity which is set if a development unit is replaced with a “new” development unit and stored beforehand in the ROM 80b or the storage 81 is set as a lifetime sheet quantity, and the set lifetime sheet quantity is stored in the ROM 80b or the storage 81. Subsequently, the cumulative number of printed sheets is reset. Alternatively, a value corresponding to 63% (100%−37%) of the lifetime sheet quantity may be considered as the cumulative number of printed sheets, and a count value of the cumulative number of printed sheets stored in the storage 81 or the ROM 80b may be updated.

According to the present embodiment, the linear function for calculating a remaining lifetime is stored in a memory (the storage 81 or the ROM 80b) of the color copier. However, the linear function may be stored in a memory (e.g., the EEPROM 121 disposed in the toner concentration sensor) of the development unit. For example, a function of a development unit may be enhanced by a change in design after mass production. In such a case, there is an advantage in a case in which each of the development unit having the enhanced function and the development unit prior to the function enhancement is considered as a “reuse item”. For example, a linear function for calculating a remaining lifetime suitable for the development unit prior to the function enhancement may differ from a linear function for calculating a remaining lifetime suitable for the development unit subsequent to the function enhancement. Thus, each of such linear functions for calculating a remaining lifetime is stored in a memory of the development unit, so that there is an advantage that a lifetime can be set with good accuracy for each of the reuse item prior to the function enhancement and the reuse item subsequent to the function enhancement.

In addition, a lifetime sheet quantity to be set when a development unit is replaced with a “new” development unit is stored in a memory of the new development unit. Thus, there is an advantage that a suitable lifetime sheet quantity can be set when a development unit is replaced with a “new” development unit having an enhanced function.

According to the present embodiment, therefore, when a development unit is replaced with a replacement “reuse” development unit, an image is formed under an image forming condition that enhances sensitivity with respect to an irregular image (a background stain or a white spot) that worsens with progress of degradation of the development unit. Since an image irregularity such as a background stain or a white spot which worsens with progress of degradation of the development unit is detected from an image that is actually formed, a degradation state of the replacement “reuse” development unit can be ascertained with good accuracy. Then, a lifetime is set based on the ascertained degradation state of the replacement “reuse” development unit. Therefore, the lifetime can be determined with high accuracy, and generation of an irregular image can be reduced.

In the present embodiment, moreover, when a development unit is replaced with a replacement “reuse” development unit (when a “reuse” development unit is first attached), a degradation state of the “reuse” development unit is ascertained and a lifetime is set. Thus, even for the “reuse item”, a lifetime can be managed based on the cumulative number of printed sheets and a lifetime sheet quantity, as similar to the “new” development unit. Accordingly, even for the “reuse item”, if the number of remaining days determined from the average number of printed sheets per day and a difference between the lifetime sheet quantity which has been set and the cumulative number of printed sheets falls below a threshold value, it is determined that a lifetime of the development unit is close to the end. In such a case, control can be performed to display a message indicating that the lifetime of the development unit is close to the end on an operation panel, or to notify a service center of the presence of the development unit which is close to the end of its lifetime.

In the above description, the development unit 30 is independently detachable from the color copier 1. However, the photoconductor unit 60 and the development unit 30 may be integrated as a process cartridge detachable from the color copier 1. In the above description, the transfer unit 32 includes the intermediate transferor and employs an intermediate transfer method. However, transfer unit 32 may employ a direct transfer method by which an image on a photoconductor is directly transferred to a sheet. Even in the direct transfer method, an absolute value of a transfer current flowing between a transfer roller and a photoconductor drum is set to be lower than that at the time of normal printing when a white spot detection image is formed, so that adhesion of carrier adhering to the photoconductor drum to a sheet is reduced, and white spots tend to be generated.

In the above description, a lifetime of the development unit is determined based on the cumulative number of sheets printed since development unit replacement. However, a lifetime of the development unit can be determined based on, for example, a cumulative drive time or a cumulative travel distance of the development unit (a sleeve of a development roller).

Alternatively, an operator may visually detect an image density of a background stain detection image formed on a prescribed sheet and the number of white spots on a white spot detection image formed on a prescribed sheet. In such a case, the operator inputs the visually detected image density and number of white spots to an operation panel. Hereinafter, such an embodiment in which an operator visually detects an image density of a background stain detection image and the number of white spots on a white spot detection image and inputs the visually detected image density and number of white spots to an operation panel is described as a modification.

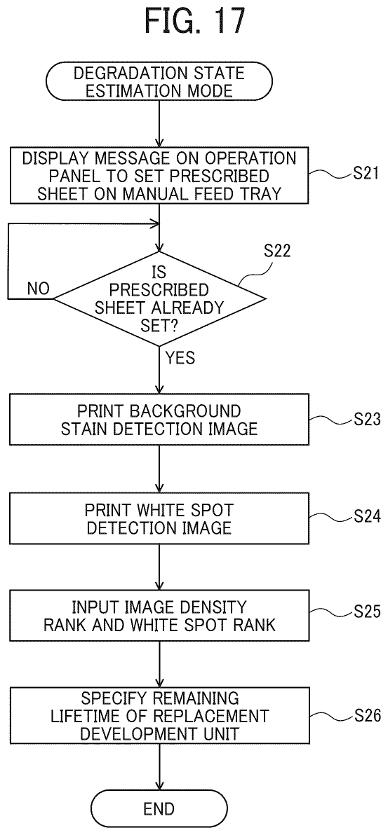

FIG. 17 is a flowchart illustrating a modification of the degradation state estimation mode. Similar to the embodiment described above, a degradation state estimation mode is executed after it is detected that a development unit 30 attached (being attached) to an apparatus body 10 is a “reuse item” and image adjustment control is executed.

In the modification, in steps S21 through S24, when the degradation state estimation mode is executed, a background stain detection image is printed on a prescribed sheet, and a white spot detection image is printed on a prescribed sheet, as similar to the embodiment described above.

Subsequently, in step S25, an operator operates an operation panel to input an image density rank of the background stain detection image printed on the prescribed sheet and a white spot rank of the white spot detection image printed on the prescribed sheet as information about an image state.

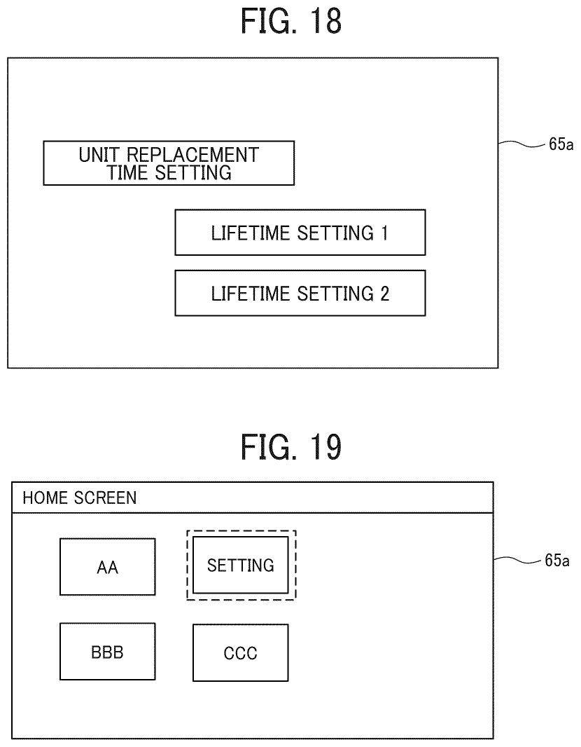

Particularly, when the printing of the background stain detection image and the printing of the white spot detection image are finished, an instruction image is displayed on a display area 65a of the operation panel 65 (See FIG. 4). The instruction image herein is an instruction to display a “unit replacement time setting screen” illustrated in FIG. 18. Based on the instruction image displayed on the display area 65a of the operation panel 65, the operator operates the operation panel to display the unit replacement time setting screen illustrated in FIG. 18.

For example, the operator presses a “setting” icon displayed on a “home screen” illustrated in FIG. 19 to display a setting screen. Then, the operator presses a “printer setting” icon displayed on the setting screen to display a printer setting screen, and presses a “data operation/management” icon out of various setting icons displayed on the printer setting screen to display a “data operation/management” screen. The operator presses a “unit replacement time setting” icon displayed on the “data operation/management” screen, and the unit replacement time setting screen illustrated in FIG. 18 is displayed. Alternatively, when the printing of the background stain detection image and the printing of the white spot detection image are finished, the unit replacement time setting screen illustrated in FIG. 18 may be displayed on the display area 65a of the operation panel 65.

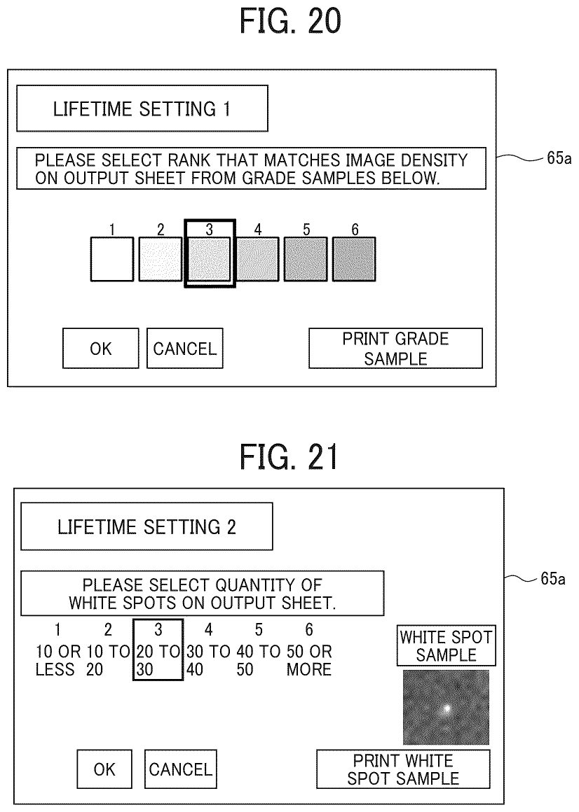

If the operator presses a “lifetime setting 1” icon illustrated in FIG. 18, an image density rank input screen illustrated in FIG. 20 is displayed. The image density rank input screen causes the operator to input an image density rank of the background stain detection image printed on the prescribed sheet. On the other hand, if the operator presses a “lifetime setting 2” icon illustrated in FIG. 18, a white spot rank input screen illustrated in FIG. 21 is displayed. The white spot rank input screen causes the operator to input a while spot rank corresponding to the number of white spots of the white spot detection image printed on the prescribed sheet.

On the image density rank input screen as illustrated in FIG. 20, a plurality of image density rank selection icons is displayed. The image density rank selection icon includes an image density rank and a reference image density corresponding to the image density rank. In the present embodiment, there are six grades of image density ranks, and six image density rank selection icons are displayed on the input screen. In the present embodiment, there are six grades of image density ranks, but it is not limited thereto. The image density ranks can be appropriately set in view of accuracy desired for lifetime setting and easiness of visual determination.

The operator compares the reference image density of each of the image density ranks displayed on the image density rank input screen with the image density of the background stain detection image printed on the prescribed sheet, and selects an image density rank selection icon of the closest image density. Upon selection of the icon, the operator presses an “OK” button, and the image density rank is confirmed.

When a “print grade sample” button illustrated in FIG. 20 is pressed, a reference image density of each image density rank as a reference image is printed on a sheet. Since a reference image density of each image density rank is printed on a sheet, the background stain detection image printed on the prescribed sheet and the reference image density of each image density rank printed on the sheet can be placed side by side and compared. Accordingly, comparison between the image density of the background stain detection image printed on the prescribed sheet and the six reference image densities printed on the sheet is easier than comparison between the image density of the background stain detection image printed on the prescribed sheet and the six reference image densities displayed on the display area 65a of the operation panel 65. Moreover, accuracy of visual determination of an image density rank by the operator can be enhanced. Accordingly, in a case where visual determination is intended to be performed with higher accuracy, or in a case where comparison using six reference image densities displayed on the display area 65a of the operation panel 65 is difficult, the operator presses the “print grade sample” icon to print images of the six reference image densities on a sheet.

On the white spot rank input screen as illustrated in FIG. 21, a plurality of white spot rank selection icons is displayed. The white spot rank selection icon includes a white spot rank and a range of white spot quantities corresponding to the white spot rank. In the present embodiment, there are six grades of white spot ranks, and six white spot rank selection icons are displayed on the white spot rank input screen. In the present embodiment, there are six grades of white spot ranks, but it is not limited thereto. The white spot ranks can be appropriately set in view of accuracy desired for lifetime setting and easiness of visual determination.

On the white spot rank input screen as illustrated in FIG. 21, a sample image of a white spot to be generated in a white spot detection image is also displayed. The operator refers to the sample image to visually find a white spot from the white spot detection image printed on the prescribed sheet, and selects an appropriate white spot rank selection icon based on the number of white spots found. Upon selection of the icon, the operator presses an “OK” button, and the white spot rank is confirmed.

The white spot rank input screen as illustrated in FIG. 21 can have an input area to which the operator inputs a numeric value of the number of white spots visually found by the operator, and a controller can specify a white spot rank based on the numeric value input by the operator.

When a “print white spot sample” icon on the white spot rank input screen is pressed, a white spot sample image (a reference image) displayed on the white spot rank input screen is printed on a sheet. Since the white spot sample image (i.e., white spot quantity information) is printed on the sheet, the printed sample image on the sheet can be brought near a portion that appears to be a white spot generated on a white spot detection image printed on a prescribed sheet, and the operator can determine whether the area is a white spot. Accordingly, the operator can refer to the white spot sample image more easily than the sample image displayed on the input screen, and thus an operation for finding a white spot is facilitated. In addition, a white spot can be visually recognized with good accuracy. Therefore, in a case where a white spot detection image has an area in which recognition of a white spot is difficult, or in a case where a white spot is intended to be recognized more accurately, the operator presses the “print white spot sample” icon to print a sample image on a sheet.

Subsequently, as illustrated in FIG. 17, in step S26, a remaining lifetime of the replacement “reuse” development unit is specified based on the confirmed image density rank, and a remaining lifetime of the replacement “reuse” development unit is specified based on the confirmed white spot rank.

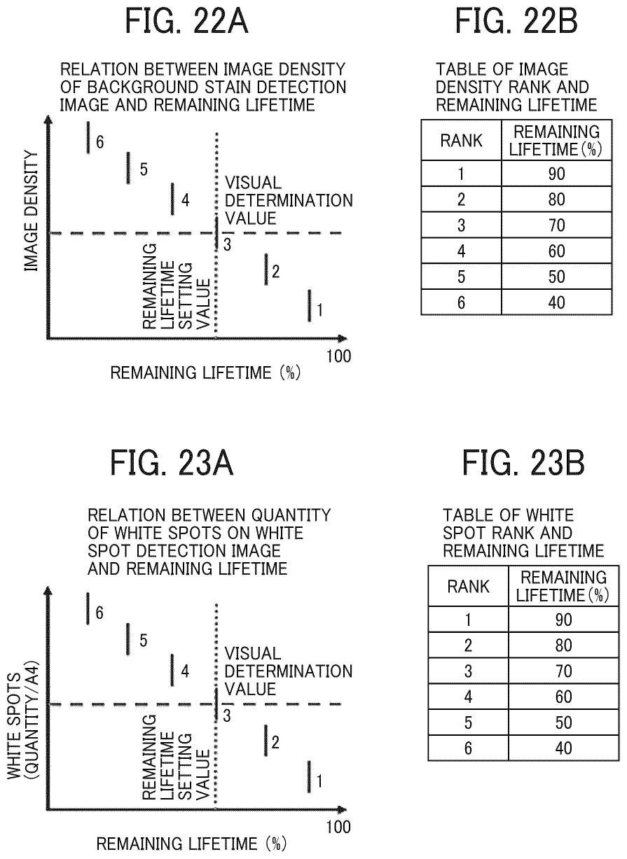

A description is given of a case in which a remaining lifetime is specified based on the confirmed image density rank. FIG. 22A illustrates a case in which a remaining lifetime is specified when an operator selects an image density rank 3, and FIG. 22B illustrates one example of a data table indicating a relation between an image density rank and a remaining lifetime stored in a ROM or a storage of the controller.

When the operator presses the “OK” button on the image density rank input screen illustrated in FIG. 20 and the image density rank is confirmed, the controller 80 specifies a remaining lifetime of the replacement “reuse” development unit based on the data table illustrated in FIG. 22B and the confirmed image density rank. For example, if the operator selects an image density rank 3, the controller 80 specifies that a remaining lifetime is 70% as illustrated in FIG. 22A.

A reference image density of each image density rank represents a median in an image density range of each image density rank. A remaining lifetime corresponding to an image density rank is a remaining lifetime corresponding to a reference image density, as illustrated in FIG. 22A. A remaining lifetime corresponding to a reference image density of each image density rank can be determined from a relation between the image density of the background stain detection image and the remaining lifetime illustrated in FIG. 14.

Next, a description is given of a case in which a remaining lifetime is specified based on a white spot rank determined by an operator. FIG. 23A illustrates a case in which a remaining lifetime is specified when an operator selects a white spot rank 3, and FIG. 23B is one example of a data table illustrating a relation between a white spot rank and a remaining lifetime stored in a ROM or a storage of the controller.

When the operator presses the “OK” button on the white spot rank input screen illustrated in FIG. 21 and the white spot rank is confirmed, the controller 80 specifies a remaining lifetime of the replacement “reuse” development unit based on the data table illustrated in FIG. 23B and the confirmed white spot rank. For example, if a white spot rank is 3, the controller specifies that a remaining lifetime based on the white spot rank is 70%, as illustrated in FIG. 23A.

The remaining lifetime corresponding to the white spot rank illustrated in FIG. 23B represents a remaining lifetime corresponding to a median of the number of white spots in each white spot rank as illustrated in FIG. 23A. The remaining lifetime of the median of the number of white spots in each white spot rank can be determined from a relation between a quantity of white spots and the remaining lifetime illustrated in FIG. 16.

Accordingly, when the remaining lifetime based on the image density rank and the remaining lifetime based on the white spot rank are specified, the modification of the degradation state estimation mode is finished. Subsequently, similar to the embodiment, a lifetime of the replacement “reuse” development unit is set based on the shorter of a remaining lifetime based on the image density rank and a remaining lifetime based on the white spot rank. For example, as illustrated in FIGS. 22A and 23A, if both of a white spot rank and an image density rank are 3, a remaining lifetime of 70% is specified. Then, a value corresponding to 70% of the lifetime sheet quantity which is set if a development unit is replaced with a “new” development unit and stored beforehand in the ROM 80b or the storage 81 is set as a lifetime sheet quantity. The set lifetime sheet quantity is stored in the ROM 80b or the storage 81. Subsequently, the cumulative number of printed sheets is reset. Alternatively, a value corresponding to 30% (100%−70%) of a lifetime sheet quantity may be considered as the cumulative number of printed sheets, and a count value of the cumulative number of printed sheets stored in the storage 81 or the ROM 80b may be updated.

According to the modification, therefore, even an image forming apparatus having no inline sensor 64 or scanner 2 can detect an image irregularity from an image actually formed, and ascertain a degradation state of a replacement “reuse” development unit. Thus, a lifetime can be set with high accuracy by a low-cost configuration. Examples of the image irregularity include background stains and white spots that worsen with progress of degradation of a development unit.

Since each of a background stain detection image formed on a prescribed sheet and a white spot detection image formed on a prescribed sheet is formed on the entire surface of the prescribed sheet, an operator may accidentally determine an image density rank from the white spot detection image or a white spot rank from the background stain detection image.

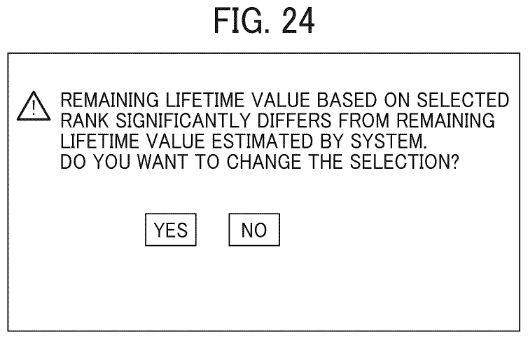

Hence, the cumulative number of printed sheets or a cumulative travel distance is stored in the EEPROM 121 which is a memory of the toner concentration sensor 56 illustrated in FIG. 5. In a case where the remaining lifetime specified based on the image density rank or the remaining lifetime specified based on the white spot rank differs from the remaining lifetime specified based on the cumulative number of printed sheets or the cumulative travel distance stored in the EEPROM 121 by a predetermined threshold value or more (e.g., 30% or more), an alert message inquiring whether to correct the selected rank may be displayed, as illustrated in FIG. 24, on the display area 65a of the operation panel 65. That is, the operator is asked whether to input an image density rank and a white spot rank again. The operator may be notified by voice other than the alert message displayed on the display area 65a of the operation panel 65.

If the operator presses a “YES” button illustrated in FIG. 24, the screen is shifted to the input screen illustrated in FIG. 20 or 21, and a rank is determined again. On the other hand, if the operator presses a “NO” button illustrated in FIG. 24, a lifetime sheet quantity is set based on the remaining lifetime specified based on the initial rank.

In the above description, each of the image density rank input screen and the white spot rank input screen includes an icon to print a sample. When such an icon is pressed, reference image densities of respective image density ranks or a white spot sample image is printed on a sheet different from a sheet on which a background stain detection image or a white spot detection image is formed. However, reference image densities of respective image density ranks may be formed together with a background stain detection image on a prescribed sheet, or a white spot sample image may be formed together with a white spot detection image on a prescribed sheet. According to such a configuration, an image density rank of the background stain detection image can be readily found or a white spot can be readily found from the white spot detection image in comparison with a case in which a reference image of each image density rank or a white spot sample image displayed on an operation panel is referred.

Alternatively, an information image for identifying whether to be used for image density rank determination or white spot rank determination may be formed together with a background stain detection image or a white spot detection image on a prescribed sheet. Such a case can prevent an operator from accidentally determining an image density rank from the white spot detection image or a white spot rank from the background stain detection image.

The present disclosure has been described above with reference to specific exemplary embodiment but is not limited thereto. Various modifications and enhancements are possible without departing from scope of the disclosure.

The above description is merely one example. The present disclosure can provide effects in aspects below.

### First Aspect

An image forming apparatus includes an apparatus body such as the apparatus body 10, a latent image bearer such as the photoconductor drum 7, a development unit such as the development unit 30 that develops a latent image on the latent image bearer, and a controller such as the controller 80 that determines a lifetime of the development unit 30. The development unit such as the development unit 30 is attachable to and detachable from the apparatus body. The controller such as the controller 80 detects whether a replacement development unit such as the development unit 30 that has been attached is a reuse item. When the controller detects that the replacement development unit is the reuse item, the controller forms a degradation state detection image (e.g., a background stain detection image or a white spot detection image) to ascertain a degradation state of the replacement development unit of the reuse item. Then, the controller sets a remaining lifetime of the replacement development unit of the reuse item based on the formed degradation state detection image.

Accordingly, to set a remaining lifetime of the replacement development unit of the reuse item, a degradation state detection image is formed to ascertain a degradation state of the development unit, and a remaining lifetime of the replacement development unit of the reuse item is set based on the actually formed degradation state detection image. Since a degradation state of the development unit can be estimated with good accuracy from the actually formed degradation state detection image, an appropriate remaining lifetime corresponding to the degradation state of the development unit based on the actually formed degradation state detection image can be set. Thus, a lifetime of the development unit of the reuse item can be determined with good accuracy.

### Second Aspect

In the first aspect, the controller such as the controller 80 estimates a degradation state of the replacement development unit of the reuse item based on the degradation state detection image (e.g., the background stain detection image or the white spot detection image), and sets a remaining lifetime of the replacement development unit of the reuse item based on the estimated degradation state of the replacement development unit of the reuse item.

Therefore, a degradation state detection image to ascertain a degradation state is formed, and a degradation state of the development unit is estimated from the degradation state detection image actually formed. This enables a degradation state of the development unit to be estimated with good accuracy. A remaining lifetime is set based on the well-estimated degradation state of the development unit, so that an appropriate remaining lifetime corresponding to the degradation state can be set for the replacement development unit of the reuse item, and a lifetime can be set with good accuracy for the replacement development unit of the reuse item.

### Third Aspect

In the first or second aspect, the image forming apparatus includes an image reader such as the inline sensor 64 that reads an image printed on a sheet such as a prescribed sheet. The controller such as the controller 80 forms the degradation state detection image (e.g., the background stain detection image or the white spot detection image) on the sheet, and sets a remaining lifetime of the replacement development unit of the reuse item based on the degradation state detection image read by the image reader.

Accordingly, in the image forming apparatus, a degradation state of the replacement development unit of the reuse item can be estimated from the degradation state detection image, and a remaining lifetime of the replacement development unit of the reuse item can be set. Thus, a burden on an operator can be reduced relative to a case in which the operator estimates a degradation state of the replacement development unit of the reuse item from a degradation state detection image formed on a sheet and inputs a remaining lifetime of the replacement development unit of the reuse item.

### Fourth Aspect

In the first or second aspect, the image forming apparatus includes an input device such as the operation panel 65 to which information is input. The controller such as the controller 80 forms the degradation state detection image (e.g., the background stain detection image or the white spot detection image) on a sheet, causes information (e.g., an image density rank or a white spot rank in the above-described embodiment) related to an image state of the degradation state detection image formed on the sheet to be input the input device, and sets a remaining lifetime of the replacement development unit of the reuse item based on the input information related to the image state.

Accordingly, as described in the modification, even an image forming apparatus having no image reader such as the inline sensor 64 that reads an image printed on a sheet such as a prescribed sheet can estimate a degradation state of the replacement development unit of the reuse item from the degradation state detection image, and can estimate a remaining lifetime of the replacement development unit of the reuse item. Thus, a lifetime of the reuse development can be set with high accuracy by a low-cost configuration.

Fifth Aspect

In the fourth aspect, the controller such as the controller 80 forms a reference image (e.g., a reference image density of each image density rank or a white spot sample image) on the sheet. The reference image is formed for an operator to determine an image state (an image density or white spots) of the degradation state detection image (the background stain detection image or the white spot detection image).

Accordingly, as described in the modification, an image state (an image density or white spots) of the degradation state detection image can be ascertained while comparing the reference image (the reference image density of each image density rank or the white spot sample image) formed on the sheet with the degradation state detection image (the background stain detection image or the white spot detection image). Thus, an operator can visually determine the image state with ease.

### Sixth Aspect

In the fourth aspect, a reference image (a reference image density of each image density rank or a white spot sample image) is formed on a sheet different from a sheet on which the degradation state detection image is to be formed.

Accordingly, as described in the modification, a reference image (a reference image density of each image density rank or a white spot sample image) can be brought next to the degradation state detection image (the background stain detection image or the white spot detection image), so that a comparison between the reference image and the degradation state detection image can be made. Thus, a similarity between the degradation state detection image and the reference image can be visually determined with good accuracy, and a degradation state of the replacement development unit of the reuse item can be estimated with good accuracy.

### Seventh Aspect

In any of the fourth through sixth aspects, the information related to the image state of the degradation state detection image such as a background stain detection image is image density information such as an image density rank of the degradation state detection image.

Accordingly, as described in the modification, a degradation state of the replacement “reuse” development unit can be ascertained in a good manner from the image density information such as an image density rank of the degradation state detection image such as a background stain detection image, and a lifetime can be set with high accuracy.

### Eighth Aspect

In any of the fourth through seventh aspects, the information related to the image state of the degradation state detection image such as a white spot detection image is information about the number of white spots in the degradation state detected image.

Accordingly, as described in the modification, a degradation state of the replacement “reuse” development unit can be ascertained in a good manner from the information about the number of white spots such as a white spot rank of the degradation state detection image such as a white spot detection image, and a lifetime can be set with high accuracy.

### Ninth Aspect

In any of the fourth through eighth aspects, the development unit includes a memory such as the EEPROM 121 in which a printed sheet quantity indicating a quantity of sheets that have been printed since beginning of use or travel distance information about a distance by which the development unit has traveled since beginning of use is stored. When a remaining lifetime of the replacement development unit of the reuse item based on the input information related to the image state and a remaining lifetime based on the printed sheet quantity or the travel distance information stored in the memory differ by a prescribed range or more, the controller such as the controller 80 inquires of an operator whether to input information related to the image state again.

Accordingly, as described in the modification, a lifetime of the replacement development unit of the reuse item is prevented from being set based on information related to a wrong image state due to an event such as a wrong operation of the input unit such as an operation panel.

### Tenth Aspect

In any of the first through ninth aspects, the controller such as the controller 80 sets a remaining lifetime based on the degradation state detection image (the background stain detection image or the white spot detection image) only when the controller such as the controller 80 detects that the replacement development unit is a reuse item.

Accordingly, a remaining lifetime is set only when a reuse development unit is first attached.

### Eleventh Aspect

In any of the first through tenth aspects, the image forming apparatus includes a charger such as the charging member 62, an exposure device such as the writing unit 34, and a transfer device such as the transfer unit 32. The charger uniformly charges the latent image bearer such as the photoconductor drum 7, and the exposure device exposes a surface of the uniformly charged latent image bearer to light to form the latent image on the surface of the latent image bearer. The transfer device eventually transfers, onto a sheet, an image that is developed by the development unit such as the development unit 30 and is on the latent image bearer. The controller such as the controller 80 causes at least one condition of a charging condition of the charger, an exposure condition of the exposure device, a development condition of the development unit, or a transfer condition of the transfer device to differ from a condition at the time of normal printing and forms the degradation state detection image (the background stain detection image or the white spot detection image). Examples of the charging condition, the exposure condition, the development condition, and the transfer condition respectively include a charging bias, an exposure amount, a development bias, and a primary transfer current.

Accordingly, the degradation state detection image can be formed under a printing condition that an irregular image such as background stains or white spots that worsen with progress of degradation of the development unit tends to appear more easily than a normal printing condition. That is, the degradation state detection image can be formed under a printing condition that sensitivity with respect to an irregular image (background stains or white spots) that worsens with progress of degradation of the development unit is enhanced. Therefore, a degradation state of the development unit can be estimated with good accuracy from the degradation state detection image, and a remaining lifetime can be set with good accuracy.

### Twelfth Aspect

In the eleventh aspect, the controller such as the controller 80 sets a background potential having a lower absolute value than a background potential at the time of normal printing, and forms the degradation state detection image.

Accordingly, as described in the embodiment, sensitivity with respect to background stains that worsen with progress of degradation of the development unit can be enhanced. Thus, detection of a background stain state from the degradation state detection image such as a background stain detection image enables a degradation state of the development unit to be estimated with good accuracy, and a remaining lifetime can be set with good accuracy.

### Thirteenth Aspect

In the eleventh aspect, the transfer device such as a transfer unit 32 includes a transfer member such as a primary transfer rollers 32f. The transfer member is disposed opposite the latent image bearer such as a photoconductor drum 7, and a transfer bias such as a primary transfer bias is applied to the transfer member. The controller such as the controller 80 not only sets a development potential having a higher absolute value than a development potential at the time of normal printing and forms an image on the laten image bearer under a solid image printing condition, but also sets an absolute value of a transfer current such as a primary transfer current flowing between the latent image bearer and the transfer member to a value lower than an absolute value of a transfer current at the time of normal printing and forms the degradation state detection image.

Accordingly, as described in the embodiment, a development potential having a higher absolute value than a development potential at the time of normal printing is set. Therefore, carrier adhesion occurs more easily, and sensitivity of the carrier adhesion with respect to the degradation of the development unit (the degradation of carrier) can be enhanced. The carrier adhesion is adhesion of carrier to a latent image bearer and worsens with progress of degradation of the development unit (degradation of carrier). An absolute value of a primary transfer current is set to be smaller than that of a primary transfer current at the time of normal printing, so that the carrier adhering to the latent image bearer does not tend to be transferred to an intermediate transfer member, and white spots that worsen with progress of the degradation of the development unit (the degradation of carrier) tend to occur. Moreover, formation of an image under a solid image printing condition enables the white spots to be detected more easily from the degradation state detection image such as a white spot detection image formed on a sheet such as a prescribed sheet.

Thus, detection of the number of white spots from the degradation state detection image such as a white spot detection image enables a degradation state of the development unit to be estimated with good accuracy, and a remaining lifetime can be set with good accuracy.

### Fourteenth Aspect

In any of the first through thirteenth aspects, based on the set remaining lifetime of the replacement development unit of the reuse item, the controller such as the controller 80 changes a numeric value (e.g., a lifetime sheet quantity and the cumulative number of printed sheets) for determination of a lifetime of the development unit.

Accordingly, the set remaining lifetime of the replacement development unit of the reuse item can be reflected in determination of a lifetime of the development unit 30, and a lifetime of the reuse development unit can be determined with good accuracy. In addition, determination of a lifetime of a new item enables a lifetime of a reuse item to be determined, so that control can be performed to notify a service person or a user even when the reuse item approaches the end of its lifetime.

### Fifteenth Aspect

In any of the first through fourteenth aspects, the development unit includes a memory such as an EEPROM 121 in which an attachment history that is a record of attachment to the apparatus body and an indication of the reuse item are stored. When a development unit is attached to the apparatus body, the controller such as the controller 80 reads information stored in the memory to determine whether the development unit has been attached by replacement and whether the development unit attached by replacement is the reuse item.

Accordingly, the information stored in the memory such as an EEPROM 121 is checked when a development unit is attached, and thus the controller such as the controller 80 can detect whether the development unit has been attached by replacement and whether the development unit attached by replacement is the reuse item.

### Sixteenth Aspect

In the fifteenth aspect, when controller such as the controller 80 detects that the development unit has been attached to the apparatus body by replacement, the controller such as the controller 80 stores the attachment history in the memory.

Accordingly, a remaining lifetime can be set based on a degradation state detection image (e.g., a background stain detection image or a white spot detection image) only when a reuse development unit is first attached.

### Seventeenth Aspect

In any of the first through sixteenth aspects, the development unit such as the development unit 30 includes a first electric circuit such as the first circuit 151 and a second electric circuit such as the second circuit 152. The first electric circuit is shiftable from an electrical state such as an energized state indicating a new item to an electrical state such as an insulated state indicating a state subsequent to the beginning of use, and the second electric circuit is shiftable from an electrical state such as an energized state indicating a reuse item to an electrical state such as an insulated state indicating a state subsequent to the beginning of use. Based on an electrical state of the first electric circuit and an electrical state of the second electric circuit, the controller such as the controller 80 detects whether the development unit has been attached to the apparatus body by replacement and whether the development unit attached to the apparatus body by replacement is the reuse item.

Accordingly, as described in the above embodiment, when the first electric circuit such as the first circuit 151 is in an electrical state, such as an energized state, indicating a new item, it can be detected that a development unit has been replaced with a “new item”. When the second electric circuit such as the second circuit 152 is in an electrical state, such as an energized state, indicating a reuse item, it can be detected that a development unit has been replaced with a “reuse item”. When each of the first electric circuit and the second electric circuit is in an electrical state, such as an insulated state, indicating a state subsequent to the beginning of use, it can be detected that an attached development unit has not been replaced.

### Eighteenth Aspect

In the seventeenth aspect, when the controller such as the controller 80 detects that the development unit attached by replacement is a new item, the controller such as the controller 80 shifts the first electric circuit such as the first circuit 151 to an electrical state, such as an insulated state, indicating a state subsequent to the beginning of use. When the controller such as the controller 80 detects that the development unit attached by replacement is the reuse item, the controller shifts the second electric circuit such as the second circuit 152 to an electrical state, such as an insulated state, indicating a state subsequent to the beginning of use.

Accordingly, after a replacement is detected, the first electric circuit such as the first circuit 151 and the second electric circuit such as the second circuit 152 are shifted to an electrical state, such as an insulated state, indicating the state subsequent to the beginning of use.

Thus, only when a development unit of a reuse item is first attached, a remaining lifetime based on a degradation state detection image (e.g., a background stain detection image or a white spot detection image) can be set.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus, comprising:
an apparatus body;
a latent image bearer;
a development unit to develop a latent image on the latent image bearer, the development unit detachable from the apparatus body; and
processing circuitry configured to determine a lifetime of the development unit,
wherein the processing circuitry is configured to:
detect whether a replacement development unit attached to the apparatus body by replacement is a reuse item;
form a degradation state detection image to ascertain a degradation state of the replacement development unit of the reuse item when the processing circuitry detects that the replacement development unit is the reuse item; and
set a remaining lifetime of the replacement development unit of the reuse item based on the degradation state detection image.

2. The image forming apparatus according to claim 1,
wherein the processing circuitry is configured to estimate a degradation state of the replacement development unit of the reuse item based on the degradation state detection image, and set a remaining lifetime of the replacement development unit of the reuse item based on the estimated degradation state of the replacement development unit of the reuse item.

3. The image forming apparatus according to claim 1, further comprising an image reader to read an image on a sheet,
wherein the processing circuitry is configured to:
form the degradation state detection image on the sheet; and
set a remaining lifetime of the replacement development unit of the reuse item based on the degradation state detection image read by the image reader.

4. The image forming apparatus according to claim 1, further comprising an input device to input information,
wherein the processing circuitry is configured to:
form the degradation state detection image on a sheet;
receive, from the input device, information related to an image state of the degradation state detection image formed on the sheet; and
set a remaining lifetime of the replacement development unit of the reuse item based on the input information related to the image state.

5. The image forming apparatus according to claim 4,
wherein the processing circuitry is configured to form, on the sheet, a reference image for an operator to determine an image state of the degradation state detection image.

6. The image forming apparatus according to claim 4,
wherein the processing circuitry is configured to form a reference image on a sheet different from a sheet on which the degradation state detection image is to be formed, the reference image being for an operator to determine an image state of the degradation state detection image.

7. The image forming apparatus according to claim 4,
wherein the information related to the image state of the degradation state detection image is image density information about the degradation state detection image.

8. The image forming apparatus according to claim 4,
wherein the information related to the image state of the degradation state detection image is information about a quantity of white spots in the degradation state detected image.

9. The image forming apparatus according to claim 4,
wherein the development unit includes a memory in which a printed sheet quantity indicating a quantity of sheets that have been printed since beginning of use of the development unit or travel distance information about a distance by which the development unit has traveled since beginning of use of the development unit is stored, and
wherein, when a remaining lifetime of the replacement development unit of the reuse item based on the input information related to the image state and a remaining lifetime based on the printed sheet quantity or the travel distance information stored in the memory differ by a prescribed range or more, the processing circuitry is configured to inquire of an operator whether to input information related to the image state again.

10. The image forming apparatus according to claim 1,
wherein the processing circuitry is configured to set a remaining lifetime based on the degradation state detection image only when the processing circuitry detects that the replacement development unit is the reuse item.

11. The image forming apparatus according to claim 1, further comprising:
a charger to uniformly charge the latent image bearer;
an exposure device to expose a surface of the uniformly charged latent image bearer to light to form the latent image on the surface of the latent image bearer; and
a transfer device to transfer, onto a sheet, an image that has been developed on the latent image bearer by the development unit,
wherein the processing circuitry is configured to set at least one condition of a charging condition of the charger, an exposure condition of the exposure device, a development condition of the development unit, or a transfer condition of the transfer device to a changed condition different from the at least one condition at normal printing and form the degradation state detection image.

12. The image forming apparatus according to claim 11,
wherein the processing circuitry is configured to set a background potential having a lower absolute value than a background potential at the normal printing, and form the degradation state detection image.

13. The image forming apparatus according to claim 12,
wherein the transfer device includes a transfer member that is disposed opposite the latent image bearer and to which a transfer bias is applied, and
wherein the processing circuitry is configured to:
set a development potential having a higher absolute value than a development potential at the normal printing and form an image on the laten image bearer under a solid image printing condition; and
set an absolute value of a transfer current flowing between the latent image bearer and the transfer member to a value lower than an absolute value of a transfer current at the normal printing and form the degradation state detection image.

14. The image forming apparatus according to claim 1,
wherein the processing circuitry is configured to change a numeric value for determination of a lifetime of the development unit, based on the set remaining lifetime of the replacement development unit of the reuse item.

15. The image forming apparatus according to claim 1,
wherein the development unit includes a memory in which an attachment history that is a record of attachment to the apparatus body and an indication of the reuse item are stored, and
wherein, when the development unit is attached to the apparatus body, the processing circuitry is configured to read information stored in the memory to determine whether the development unit has been attached by replacement and whether the development unit attached by replacement is the reuse item.

16. The image forming apparatus according to claim 15,
wherein the processing circuitry is configured to store the attachment history into the memory when the processing circuitry detects that the development unit has been attached by replacement.

17. The image forming apparatus according to claim 1,
wherein the development unit includes:
a first electric circuit to shift from an electrical state indicating a new item to an electrical state indicating a state subsequent to beginning of use of the new item; and
a second electric circuit to shift from an electrical state indicating a reuse item to an electrical state indicating a state subsequent to beginning of use of the reuse item, and
wherein the processing circuitry is configured to detect whether the development unit has been attached to the apparatus body by replacement and whether the development unit attached by replacement is the reuse item, based on an electrical state of the first electric circuit and an electrical state of the second electric circuit.

18. The image forming apparatus according to claim 17,
wherein the processing circuitry is configured to shift the first electric circuit to the electrical state indicating the state subsequent to beginning of use of the new item, when the processing circuitry detects that the development unit attached by replacement is the new item, and
wherein the processing circuitry is configured to shift the second electric circuit to an electrical state indicating the state subsequent to beginning of use of the reuse item, when the processing circuitry detects that the development unit attached by replacement is the reuse item.
